(19) United States
(12) Patent Application Publication
(10) Pub. No.: US 2025/0271643 A1
(43) Pub. Date: Aug. 28, 2025

(54) Lens Assembly

(71) Applicant: Asia Optical Co., Inc., Taichung (TW)

(72) Inventors: Jia-Sin Chen, Taichung (TW); Hsi-Ling Chang, Taichung (TW); Bo-Yan Chen, Taichung (TW); Shu-Hung Lin, Taichung (TW)

(21) Appl. No.: 18/937,195

(22) Filed: Nov. 5, 2024

(30) Foreign Application Priority Data
Feb. 23, 2024 (CN) 202410204408.4
Mar. 28, 2024 (CN) 202410369683.1

(51) Int. Cl. G02B 13/00; G02B 9/62

(52) U.S. Cl. CPC G02B 13/0045; G02B 9/62

(57) ABSTRACT

A lens assembly includes a first lens, a second lens, a third lens, a fourth lens, a fifth lens, and a sixth lens. The first lens is a meniscus lens with positive refractive power and includes a convex surface facing an object side and a concave surface facing an image side. The second lens is a meniscus lens with negative refractive power and includes a convex surface facing the object side and a concave surface facing the image side. The third lens is with refractive power. The fourth lens is with refractive power. The fifth lens is with positive refractive power. The sixth lens is with refractive power. The first lens, the second lens, the third lens, the fourth lens, the fifth lens, and the sixth lens are arranged in order from the object side to the image side along an optical axis.

### BACKGROUND OF THE INVENTION

### Field of the Invention

The present invention relates to a lens assembly.

### Description of the Related Art

The current development trend of a lens assembly is toward high resolution. Additionally, the lens assembly is developed to have miniaturization in accordance with different application requirements. However, the known lens assembly can't satisfy such requirements. Therefore, the lens assembly needs a new structure in order to meet the requirements of high resolution and miniaturization at the same time.

### BRIEF SUMMARY OF THE INVENTION

The invention provides a lens assembly to solve the above problems. The lens assembly of the invention is provided with characteristics of an increased resolution, a decreased total lens length, and still has a good optical performance.

The lens assembly in accordance with an exemplary embodiment of the invention includes a first lens, a second lens, a third lens, a fourth lens, a fifth lens, and a sixth lens. The first lens is a meniscus lens with positive refractive power and includes a convex surface facing an object side and a concave surface facing an image side. The second lens is a meniscus lens with negative refractive power and includes a convex surface facing the object side and a concave surface facing the image side. The third lens is with refractive power. The fourth lens is with refractive power and includes a convex surface facing the image side. The fifth lens is a biconvex lens with positive refractive power and includes a convex surface facing the object side and another convex surface facing the image side. The sixth lens is with refractive power. The first lens, the second lens, the third lens, the fourth lens, the fifth lens, and the sixth lens are arranged in order from the object side to the image side along an optical axis. The lens assembly satisfies at least one of the following conditions: −100 mm≤fB+fC≤50 mm; 1≤CT2/CT1≤7; 0.2≤Vd4/Vd5≤3.1; 6.1<TTL/CT1<7.4; −3 mm≤fE+fF≤9 mm; 0.4≤|fF/fE|≤1.3; 0.6≤(R12−R11)/(R21−R22)≤2.2; 5≤TTL/BFL≤10; wherein fB is an effective focal length of the lens second closest to the object side, fC is an effective focal length of the lens third closest to the object side, CT1 is an interval from an object side surface of the first lens to an image side surface of the second lens along the optical axis, CT2 is an interval from the image side surface of the second lens to an image side surface of the sixth lens along the optical axis, Vd4 is an Abbe number of the lens fourth closest to the object side, Vd5 is an Abbe number of the lens fifth closest to the object side, TTL is an interval from the object side surface of the first lens to an image plane along the optical axis, R11 is a radius of curvature of the object side surface of the first lens, R12 is a radius of curvature of an image side surface of the first lens, R21 is a radius of curvature of an object side surface of the second lens, R22 is a radius of curvature of the image side surface of the second lens, fE is an effective focal length of the lens fifth closest to the object side, fF is an effective focal length of the lens sixth closest to the object side, and BFL is an interval from an image side surface of the lens closest to the image side to the image plane along the optical axis.

In another exemplary embodiment, the third lens is a meniscus lens; and the sixth lens is with negative refractive power.

In yet another exemplary embodiment, the sixth lens is a biconcave lens and further includes another concave surface facing the object side.

In another exemplary embodiment, the third lens is with positive refractive power and includes a concave surface facing the object side and a convex surface facing the image side.

In yet another exemplary embodiment, the fourth lens is a meniscus lens with negative refractive power and further includes a concave surface facing the object side.

In another exemplary embodiment, the lens assembly further includes a seventh lens disposed between the second lens and the third lens, wherein the seventh lens is a biconcave lens with negative refractive power and includes a concave surface facing the object side and another concave surface facing the image side.

In yet another exemplary embodiment, the third lens is with negative refractive power and includes a convex surface facing the object side and a concave surface facing the image side.

In another exemplary embodiment, the fourth lens is a biconvex lens with positive refractive power and further includes another convex surface facing the object side.

In yet another exemplary embodiment, the lens assembly further includes a stop disposed between the object side and the first lens, wherein the first lens and the second lens are cemented.

In another exemplary embodiment, the lens assembly satisfies at least one of the following conditions: 11.9<(f+TTL)/CT1<13.3; 6<(f+BFL)/CT1<7; 27 mm²<fA×D1obj<51 mm²; 2.0<(TTL+BFL)/D1obj<3.3; 7 mm<D1obj+R11<11 mm; 15 mm<f+CT2<18 mm; 3.5<(TTL/BFL)−(D1obj/BFL)<6.1; 9.3 mm²<f×T1<12.5 mm²; TC12-0 mm; −60 mm≤fA+fD≤50 mm; −3≤f/(fA+fB)≤−0.1; wherein f is an effective focal length of the lens assembly, fA is an effective focal length of the lens closest to the object side, TTL is the interval from the object side surface of the first lens to the image plane along the optical axis, BFL is the interval from the image side surface of the lens closest to the image side to the image plane along the optical axis, T1 is an interval from the object side surface of the first lens to the image side surface of the first lens along the optical axis, CT1 is the interval from the object side surface of the first lens to the image side surface of the second lens along the optical axis, CT2 is the interval from the image side surface of the second lens to the image side surface of the sixth lens along the optical axis, D1obj is an effective optical diameter of the object side surface of the first lens, R11 is the radius of curvature of the object side surface of the first lens, TC12 is an interval from the image side surface of the first lens to the object side surface of the second lens along the optical axis, fD is an effective focal length of the lens fourth closest to the object side, and fB is the effective focal length of the lens second closest to the object side.

In yet another exemplary embodiment, the lens assembly further includes a seventh lens disposed between the second lens and the third lens, wherein the seventh lens includes a concave surface facing the image side.

In another exemplary embodiment, the third lens is with positive refractive power; the sixth lens is with positive refractive power; and the seventh lens is with negative refractive power.

In yet another exemplary embodiment, the fourth lens is a meniscus lens and further includes a concave surface facing the object side; the sixth lens is a biconvex lens and includes a convex surface facing the object side and another convex surface facing the image side; and the seventh lens is a meniscus lens and further includes a convex surface facing the object side.

In another exemplary embodiment, the third lens is a biconvex lens and includes a convex surface facing the object side and another convex surface facing the image side; and the fourth lens is with negative refractive power.

In yet another exemplary embodiment, the lens assembly further includes an eighth lens disposed between the sixth lens and the image side and a ninth lens disposed between the eighth lens and the image side, wherein the eighth lens is with negative refractive power and the ninth lens is with positive refractive power.

In another exemplary embodiment, the eighth lens is a biconcave lens and includes a concave surface facing the object side and another concave surface facing the image side.

In yet another exemplary embodiment, the ninth lens is a biconvex lens and includes a convex surface facing the object side and another convex surface facing the image side.

In another exemplary embodiment, the third lens is a meniscus lens and includes a concave surface facing the object side and a convex surface facing the image side; and the fourth lens is with positive refractive power.

In yet another exemplary embodiment, the lens assembly satisfies at least one of the following conditions: 1.56≤fG/f≤1.94; 0.8≤|fD/fE|≤1.2; 4.8≤R12/T1≤6.2; −4.9≤R62/T6≤−4.3; 3≤|R41/R42|≤5.7; −0.27≤(R11−R12)/TTL≤−0.16; wherein f is an effective focal length of the lens assembly, fD is an effective focal length of the lens fourth closest to the object side, fE is the effective focal length of the lens fifth closest to the object side, fG is an effective focal length of the lens seventh closest to the object side, R11 is the radius of curvature of the object side surface of the first lens, R12 is the radius of curvature of the image side surface of the first lens, R41 is a radius of curvature of an object side surface of the lens fourth closest to the object side, R42 is a radius of curvature of an image side surface of the lens fourth closest to the object side, R62 is a radius of curvature of an image side surface of the lens sixth closest to the object side, T1 is an interval from the object side surface of the first lens to the image side surface of the first lens along the optical axis, T6 is an interval from an object side surface of the lens sixth closest to the object side to an image side surface of the lens sixth closest to the object side along the optical axis, and TTL is the interval from the object side surface of the first lens to the image plane along the optical axis.

In another exemplary embodiment, the lens assembly further includes a stop disposed between the seventh lens and the third lens or disposed between the third lens and the fourth lens.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a lens layout and optical path diagram of a lens assembly in accordance with a first embodiment of the invention;

FIG. 2 depicts a field curvature diagram of the lens assembly in accordance with the first embodiment of the invention;

FIG. 3 depicts a distortion diagram of the lens assembly in accordance with the first embodiment of the invention;

FIG. 4 depicts a modulation transfer function diagram of the lens assembly in accordance with the first embodiment of the invention;

FIG. 5 is a lens layout and optical path diagram of a lens assembly in accordance with a second embodiment of the invention;

FIG. 6 depicts a field curvature diagram of the lens assembly in accordance with the second embodiment of the invention;

FIG. 7 depicts a distortion diagram of the lens assembly in accordance with the second embodiment of the invention;

FIG. 8 depicts a modulation transfer function diagram of the lens assembly in accordance with the second embodiment of the invention;

FIG. 9 is a lens layout and optical path diagram of a lens assembly in accordance with a third embodiment of the invention;

FIG. 10 is a lens layout and optical path diagram of a lens assembly in accordance with a fourth embodiment of the invention;

FIG. 11 is a lens layout and optical path diagram of a lens assembly in accordance with a fifth embodiment of the invention;

FIGS. 12, 13, 14, and 15 depict a field curvature diagram, a distortion diagram, a modulation transfer function diagram, and a through focus modulation transfer function diagram of the lens assembly in accordance with the fifth embodiment of the invention, respectively;

FIG. 16 is a lens layout and optical path diagram of a lens assembly in accordance with a sixth embodiment of the invention;

FIGS. 17, 18, 19, and 20 depict a field curvature diagram, a distortion diagram, a modulation transfer function diagram, and a through focus modulation transfer function diagram of the lens assembly in accordance with the sixth embodiment of the invention, respectively;

FIG. 21 is a lens layout and optical path diagram of a lens assembly in accordance with a seventh embodiment of the invention;

FIG. 22 is a lens layout and optical path diagram of a lens assembly in accordance with an eighth embodiment of the invention; and

FIGS. 23, 24, 25, and 26 depict a field curvature diagram, a distortion diagram, a modulation transfer function diagram, and a through focus modulation transfer function diagram of the lens assembly in accordance with the eighth embodiment of the invention, respectively.

### DETAILED DESCRIPTION OF THE INVENTION

The following description is made for the purpose of illustrating the general principles of the invention and should not be taken in a limiting sense. The scope of the invention is best determined by reference to the appended claims.

The present invention provides a lens assembly including a first lens, a second lens, a third lens, a fourth lens, a fifth lens, and a sixth lens. The first lens is a meniscus lens with positive refractive power and includes a convex surface facing an object side and a concave surface facing an image side. The second lens is a meniscus lens with negative refractive power and includes a convex surface facing the object side and a concave surface facing the image side. The third lens is with refractive power. The fourth lens is with refractive power and includes a convex surface facing the image side. The fifth lens is a biconvex lens with positive refractive power and includes a convex surface facing the object side and another convex surface facing the image side. The sixth lens is with refractive power. The first lens, the second lens, the third lens, the fourth lens, the fifth lens, and the sixth lens are arranged in order from the object side to the image side along an optical axis. The lens assembly satisfies at least one of the following conditions: −100 mm≤fB+fC≤50 mm; 1≤CT2/CT1≤7; 0.2≤Vd4/Vd5≤3.1; 6.1<TTL/CT1<7.4; −3 mm≤fE+fF≤9 mm; 0.4≤|fF/fE|≤1.3; 0.6≤(R12−R11)/(R21−R22)≤2.2; 5≤TTL/BFL≤10; wherein fB is an effective focal length of the lens second closest to the object side, fC is an effective focal length of the lens third closest to the object side, CT1 is an interval from an object side surface of the first lens to an image side surface of the second lens along the optical axis, CT2 is an interval from the image side surface of the second lens to an image side surface of the sixth lens along the optical axis, Vd4 is an Abbe number of the lens fourth closest to the object side, Vd5 is an Abbe number of the lens fifth closest to the object side, TTL is an interval from the object side surface of the first lens to an image plane along the optical axis, R11 is a radius of curvature of the object side surface of the first lens, R12 is a radius of curvature of an image side surface of the first lens, R21 is a radius of curvature of an object side surface of the second lens, R22 is a radius of curvature of the image side surface of the second lens, fE is an effective focal length of the lens fifth closest to the object side, fF is an effective focal length of the lens sixth closest to the object side, and BFL is an interval from an image side surface of the lens closest to the image side to the image plane along the optical axis. A lens assembly of the present invention can achieve basic operation when the lens assembly satisfies the above features and at least one of the above conditions, and does not need other additional features and conditions.

Referring to Table 1, Table 2, Table 4, Table 5, Table 7, Table 8, Table 10, and Table 11, wherein Table 1, Table 4, Table 7, and Table 10 show optical specification in accordance with a first, second, third, and fourth embodiments of the invention, respectively, and Table 2, Table 5, Table 8, and Table 11 show aspheric coefficients of each aspheric lens in Table 1, Table 4, Table 7, and Table 10, respectively.

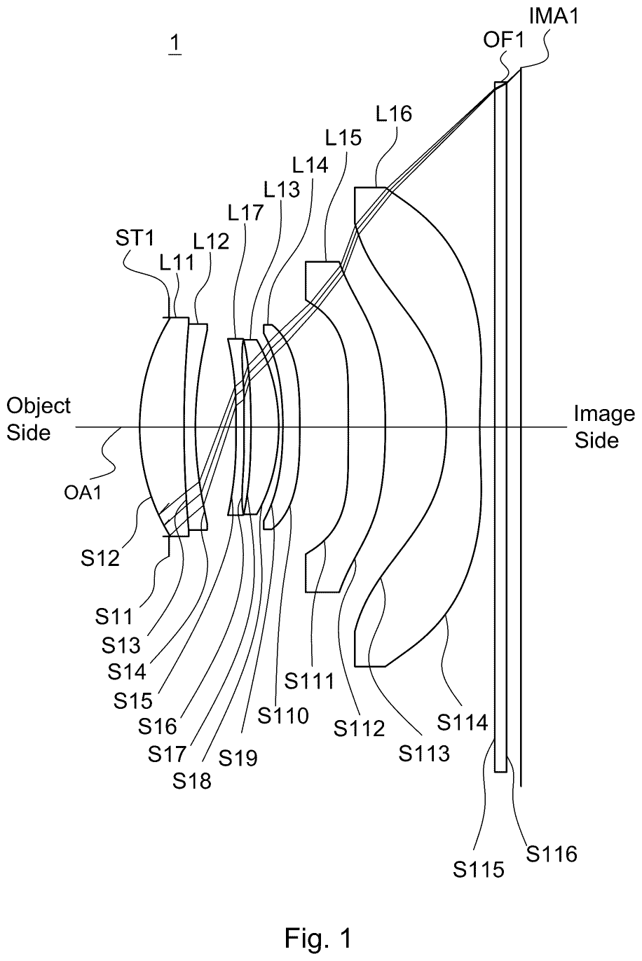

FIGS. 1, 5, 9, 10 are lens layout and optical path diagrams of the lens assemblies in accordance with the first, second, third, and fourth embodiments of the invention, respectively.

The first lenses L11, L21, L31, L41 are meniscus lenses with positive refractive power, wherein the object side surfaces S12, S22, S32, S42 are convex surfaces, the image side surfaces S13, S23, S33, S43 are concave surfaces, the object side surfaces S12, S22, S32, S42 are aspheric surfaces, and the image side surfaces S13, S23, S33, S43 are spherical surfaces.

The second lenses L12, L22, L32, L42 are meniscus lens with negative refractive power, wherein the object side surfaces S13, S23, S33, S43 are convex surfaces, the image side surfaces S14, S24, S34, S44 are concave surfaces, and the object side surfaces S13, S23, S33, S43 are spherical surfaces.

The first lenses L11, L21, L31, L41 and the second lenses L12, L22, L32, L42 are cemented and there is no air gap between the first lenses L11, L21, L31, L41 and the second lenses L12, L22, L32, L42.

The third lenses L13, L23, L33, L43 are with refractive power, wherein both of the object side surfaces S17, S25, S35, S47 and image side surfaces S18, S26, S36, S48 are aspheric surfaces.

The fourth lenses L14, L24, L34, L44 are with refractive power, wherein the image side surfaces S110, S28, S38, S410 are convex surfaces and both of the object side surfaces S19, S27, S37, S49 and image side surfaces S110, S28, S38, S410 are aspheric surfaces.

The fifth lenses L15, L25, L35, L45 are biconvex lenses with positive refractive power, wherein the object side surfaces S111, S29, S39, S411 are convex surfaces, the image side surfaces S112, S210, S310, S412 are convex surfaces, and both of the object side surfaces S111, S29, S39, S411 and image side surfaces S112, S210, S310, S412 are aspheric surfaces.

The sixth lenses L16, L26, L36, L46 are biconcave lenses with negative refractive power, wherein the object side surfaces S113, S211, S311, S413 are concave surfaces, the image side surfaces S114, S212, S312, S414 are concave surfaces, and both of the object side surfaces S113, S211, S311, S413 and image side surfaces S114, S212, S312, S414 are aspheric surfaces.

In addition, the lens assemblies 1, 2, 3, and 4 satisfy at least one of the following conditions (1)-(16):

$$11.9 < ( f + TTL ) / CT 1 < 13.3 ; \qquad ( 1 )$$

$$6.1 < TTL / CT 1 < 7.4 ; \qquad ( 2 )$$

$$6 < ( f + B FL ) / CT 1 < 7 ; \qquad ( 3 )$$

$$27 {mm}^{2} < fA \times D 1 obj < 51 {mm}^{2} ; \qquad ( 4 )$$

$$2. < ( T T L + B FL ) / D 1 obj < 3.3 ; \qquad ( 5 )$$

$$7 mm < D 1 obj + R 11 < 11 mm ; \qquad ( 6 )$$

$$15 mm < f + C T 2 < 18 mm ; \qquad ( 7 )$$

$$3.5 < ( TTL / BFL ) - ( D 1 obj / BFL ) < 6.1 ; \qquad ( 8 )$$

$$9.3 {mm}^{2} < f \times T 1 < 12.5 {mm}^{2} ; \qquad ( 9 )$$

$$TC 12 = 0 mm ; \qquad ( 10 )$$

$$- 100 mm \leq fB + f C \leq 50 mm ; \qquad ( 11 )$$

$$- 60 mm \leq fA + f D \leq 50 mm ; \qquad ( 12 )$$

$$- 3 \leq f / ( fA + f B ) \leq - 0.1 ; \qquad ( 13 )$$

$$- 3 mm \leq fE + f F \leq 9 mm ; \qquad ( 14 )$$

$$1 \leq CT 2 / CT 1 \leq 7 ; \qquad ( 15 )$$

$$0.2 \leq Vd 4 / Vd 5 \leq 3.1 ; \qquad ( 16 )$$

wherein: f is an effective focal length of the lens assemblies 1, 2, 3, 4 for the first to fourth embodiments; fA is an effective focal length of the lenses L11, L21, L31, L41 closest to the object side for the first to fourth embodiments; fB is an effective focal length of the lenses L12, L22, L32, L42 second closest to the object side for the first to fourth embodiments; fC is an effective focal length of the lenses L17, L23, L33, L47 third closest to the object side for the first to fourth embodiments; fD is an effective focal length of the lenses L13, L24, L34, L43 fourth closest to the object side for the first to fourth embodiments; fE is an effective focal length of the lenses L14, L25, L35, L44 fifth closest to the object side for the first to fourth embodiments; fF is an effective focal length of the lenses L15, L26, L36, L45 sixth closest to the object side for the first to fourth embodiments; TTL is an interval from the object side surfaces S12, S22, S32, S42 of the first lenses L11, L21, L31, L41 to the image planes IMA1, IMA2, IMA3, IMA4 along the optical axes OA1, OA2, OA3, OA4 for the first to fourth embodiments; BFL is an interval from the image side surfaces S114, S212, S312, S414 of the lenses L16, L26, L36, L46 closest to the image side to the image planes IMA1, IMA2, IMA3, IMA4 along the optical axes OA1, OA2, OA3, OA4 for the first to fourth embodiments; T1 is an interval from the object side surfaces S12, S22, S32, S42 of the first lenses L11, L21, L31, L41 to the image side surfaces S13, S23, S33, S43 of the first lenses L11, L21, L31, L41 along the optical axes OA1, OA2, OA3, OA4 for the first to fourth embodiments; CT1 is an interval from the object side surfaces S12, S22, S32, S42 of the first lenses L11, L21, L31, L41 to the image side surfaces S14, S24, S34, S44 of the second lenses L12, L22, L32, L42 along the optical axes OA1, OA2, OA3, OA4 for the first to fourth embodiments; CT2 is an interval from the image side surfaces S14, S24, S34, S44 of the second lenses L12, L22, L32, L42 to the image side surfaces S114, S212, S312, S414 of the sixth lenses L16, L26, L36, L46 along the optical axes OA1, OA2, OA3, OA4 for the first to fourth embodiments; D1obj is an effective optical diameter of the object side surfaces S12, S22, S32, S42 of the first lenses L11, L21, L31, L41 for the first to fourth embodiments; R11 is a radius of curvature of the object side surfaces S12, S22, S32, S42 of the first lenses L11, L21, L31, L41 for the first to fourth embodiments; TC12 is an interval from the image side surfaces S13, S23, S33, S43 of the first lenses L11, L21, L31, L41 to the object side surfaces S13, S23, S33, S43 of the second lenses L12, L22, L32, L42 along the optical axes OA1, OA2, OA3, OA4 for the first to fourth embodiments; Vd4 is an Abbe number of the lenses L13, L24, L34, L43 fourth closest to the object side for the first to fourth embodiments; and Vd5 is an Abbe number of the lenses L14, L25, L35, L44 fifth closest to the object side for the first to fourth embodiments. Making lens assemblies 1, 2, 3, and 4 having increased resolution and corrected aberration. A lens assembly of the present invention is a preferred embodiment of the present invention when the lens assembly satisfies at least one of the above conditions (1)-(16).

When the condition (1), (2), or (3): 11.9<(f+TTL)/CT1<13.3, 6.1<TTL/CT1<7.4, or 6<(f+BFL)/CT1<7 is satisfied, the total lens length of the lens assembly can be decreased effectively. When the condition (4), (6), or (9): 27 mm²<fA×D1obj<51 mm², 7 mm<D1obj+R11<11 mm, or 9.3 mm²<f×T1<12.5 mm² is satisfied, conducive to the setting of the first lens and the aberration can be corrected effectively. When the condition (5) or (8): 2.0<(TTL+BFL)/D1obj<3.3 or 3.5<(TTL/BFL)−(D1obj/BFL)<6.1 is satisfied, the space can be used effectively and the volume of the lens assembly can be decreased effectively. When the condition (7): 15 mm<f+CT2<18 mm is satisfied, the chromatic aberration can be corrected effectively and resolution can be increased effectively. When the condition (10): TC12=0 mm is satisfied, helping the first lens and the second lens matching up to reduce ghost image effectively. When the condition (11), (12), or (14): −100 mm≤fB+fC≤50 mm, −60 mm≤fA+fD≤50 mm, or −3 mm≤fE+fF≤9 mm is satisfied, helping the lens assembly to maintain good optical performance. When the condition (13): −3≤f/(fA+fB)≤−0.1 is satisfied, the refractive power of the lens closest to the object side and the lens second closest to the object side can distributed effectively and maintaining good optical performance. When the condition (15): 1≤CT2/CT1≤7 is satisfied, the chief ray angle of the lens assembly can be controlled effectively and maintaining good optical performance.

A detailed description of a lens assembly in accordance with a first embodiment of the invention is as follows. Referring to FIG. 1, the lens assembly 1 includes a stop ST1, a first lens L11, a second lens L12, a seventh lens L17, a third lens L13, a fourth lens L14, a fifth lens L15, a sixth lens L16, and an optical filter OF1, all of which are arranged in order from an object side to an image side along an optical axis OA1. In operation, the light from the object side is imaged on an image plane IMA1.

According to the foregoing, wherein: the image side surface S14 of the second lens L12 is an aspheric surface; the seventh lens L17 is disposed between the second lens L12 and the third lens L13, wherein the seventh lens L17 is a biconcave lens with negative refractive power, the object side surface S15 is a concave surface, the image side surface S16 is a concave surface, and both of the object side surface S15 and image side surface S16 are aspheric surfaces; the third lens L13 is a meniscus lens with positive refractive power, wherein the object side surface S17 is a concave surface and the image side surface S18 is a convex surface; the fourth lens L14 is a meniscus lens with negative refractive power, wherein the object side surface S19 is a concave surface; both of the object side surface S115 and image side surface S116 of the optical filter OF1 are plane surfaces; and with the above design of the lenses, stop ST1, and at least one of the conditions (1)-(16) satisfied, the lens assembly 1 can have an effective increased resolution and an effective corrected aberration.

The lens assembly 1 further satisfies at least one of the following conditions (17)-(19):

$$27 {mm}^{2} < fA \times D 1 obj < 33 {mm}^{2} ; \qquad ( 17 )$$

$$3.7 < ( TTL / BFL ) - ( D 1 obj / BFL ) < 5.2 ; \qquad ( 18 )$$

$$4.1 < ( TTL / BFL ) - ( D 1 obj / BFL ) < 5.7 ; \qquad ( 19 )$$

Table 1 shows the optical specification of the lens assembly 1 in FIG. 1.

TABLE 1
Effective Focal Length = 8.47 mm F-number = 1.63
Total Lens Length = 10.151 mm Field of View = 86.72 degrees

| | Radius of | | | | Effective | |
|---|---|---|---|---|---|---|
| Surface | Curvature | Thickness | | | Focal Length | |
| Number | (mm) | (mm) | Nd | Vd | (mm) | Remark |
| S11 | ∞ | −0.782 | | | | ST1 |
| S12 | 4.478 | 1.181 | 1.88 | 37.20 | 6.044 | L11 |
| S13 | 23.632 | 0.302 | 2.00 | 19.32 | −11.55 | L12 |
| S14 | 7.766 | 1.082 | | | | |
| S15 | −50.086 | 0.211 | 1.67 | 19.24 | −54.9 | L17 |
| S16 | 144.801 | 0.187 | | | | |
| S17 | −15.885 | 0.741 | 1.53 | 56.11 | 8.328 | L13 |
| S18 | −3.546 | 0.108 | | | | |
| S19 | −7.460 | 0.450 | 1.62 | 25.92 | −16.694 | L14 |
| S110 | −27.408 | 1.292 | | | | |
| S111 | 92.938 | 0.987 | 1.67 | 19.24 | 16.159 | L15 |
| S112 | −12.357 | 1.625 | | | | |
| S113 | −5.570 | 0.888 | 1.62 | 25.92 | −5.909 | L16 |
| S114 | 11.320 | 0.400 | | | | |
| S115 | ∞ | 0.310 | 1.52 | 64.19 | | OF1 |
| S116 | ∞ | 0.338 | | | | |

The aspheric surface sag z of each lens in table 1 can be calculated by the following formula:

$$z = c {h}^{2} / \{ 1 + {[ 1 - ( k + 1 ) {c}^{2} {h}^{2} ]}^{1 / 2} \} + A {h}^{4} + B {h}^{6} + C {h}^{8} + D {h}^{10} + E {h}^{12} + F {h}^{14} + G {h}^{16}$$

where c is curvature, h is the vertical distance from the lens surface to the optical axis, k is conic constant and A, B, C, D, E, F, and G are aspheric coefficients.

In the first embodiment, the conic constant k and the aspheric coefficients A, B, C, D, E, F, G of each aspheric lens are shown in Table 2.

TABLE 2

| Surface | | A | B | C | |
|---|---|---|---|---|---|
| Number | k | E | F | G | D |
| S12 | −8.05E−01 | 1.27E−03 | −9.94E−05 | 9.98E−05 | −3.54E−05 |
| | | 6.71E−06 | −6.38E−07 | 2.31E−08 | |
| S14 | 6.93E+00 | −1.62E−03 | −1.08E−03 | 6.34E−04 | −2.60E−04 |
| | | 5.69E−05 | −6.67E−06 | 3.10E−07 | |
| S15 | −1.80E+03 | −2.33E−02 | 3.67E−04 | 1.37E−03 | 4.90E−04 |
| | | −3.69E−04 | 6.65E−05 | −3.85E−06 | |
| S16 | 4.86E+03 | −1.73E−02 | −1.68E−03 | 1.07E−03 | 1.55E−03 |
| | | −7.60E−04 | 1.25E−04 | −7.09E−06 | |
| S17 | −4.02E+02 | −6.63E−03 | −2.84E−03 | 8.05E−04 | 2.03E−04 |
| | | −4.55E−05 | −1.56E−05 | 3.14E−06 | |
| S18 | −1.28E+01 | −1.20E−02 | −1.08E−03 | 3.66E−04 | 2.34E−05 |
| | | −5.57E−06 | −7.91E−06 | 1.46E−06 | |
| S19 | −6.97E+01 | −2.24E−02 | 2.12E−03 | 3.04E−04 | −7.84E−05 |
| | | −2.28E−05 | 6.29E−06 | −3.29E−07 | |
| S110 | 1.17E+02 | −2.39E−02 | 3.45E−03 | −4.10E−04 | −1.28E−05 |
| | | 3.96E−06 | 8.14E−08 | −5.61E−08 | |
| S111 | 9.47E+02 | −1.06E−02 | −2.15E−04 | −3.70E−05 | −6.00E−06 |
| | | 3.58E−06 | −5.65E−07 | 2.74E−08 | |
| S112 | 3.09E−01 | −4.81E−03 | −3.01E−04 | 2.58E−05 | −8.89E−08 |
| | | 3.51E−07 | −3.55E−08 | 9.10E−10 | |
| S113 | 1.12E−01 | −1.53E−02 | 1.66E−03 | −7.77E−05 | 2.15E−06 |
| | | −8.53E−09 | −1.49E−09 | 3.27E−11 | |
| S114 | −8.14E+01 | −8.42E−03 | 5.86E−04 | −2.28E−05 | 5.77E−08 |
| | | 2.71E−08 | −9.51E−10 | 1.08E−11 | |

Table 3 shows the parameters and condition values for conditions (1)-(19) in accordance with the first embodiment of the invention. It can be seen from Table 3 that the lens assembly 1 of the first embodiment satisfies the conditions (1)-(19).

TABLE 3

| | | | | | | | | |
|---|---|---|---|---|---|---|---|---|
| CT1 | 1.483 | mm | CT2 | 7.571 | mm | BFL | 1.098 | mm |
| D1obj | 5.15 | mm | fA | 6.044 | mm | fB | −11.55 | mm |
| fC | −54.9 | mm | fD | 8.328 | mm | fE | −16.694 | mm |
| fF | 16.159 | mm | TC12 | 0 | mm | T1 | 1.181 | mm |

| (f + TTL)/CT1 | 12.56 | | TTL/CT1 | 6.84 | (f + BFL)/CT1 | 6.45 | |
|---|---|---|---|---|---|---|---|
| fA × D1obj | 31.12 | mm² | (TTL + BFL)/ | 2.18 | D1obj + R11 | 9.63 | mm |

D1obj

| | | | | | | | |
|---|---|---|---|---|---|---|---|
| f + CT2 | 16.04 | mm | (TTL/BFL) − | 4.55 | f × T1 | 10.00 | mm² |

(D1obj/BFL)

| | | | | | | | |
|---|---|---|---|---|---|---|---|
| fB + fC | −66.45 | mm | fA + fD | 14.37 | mm | f/(fA + fB) | −1.54 |

| | | | | | | |
|---|---|---|---|---|---|---|
| fE + fF | −0.54 | mm | CT2/CT1 | 5.11 | Vd4/Vd5 | 2.16 |

The lens assembly 1 can meet the basic operation requirements when it is modified to only satisfies at least one of the conditions (1)-(19); the first lens having positive refractive power, a convex surface facing the object side, and a concave surface facing the image side; the second lens having negative refractive power, a convex surface facing the object side, and a concave surface facing the image side; the seventh lens having negative refractive power; the third lens having refractive power; the fourth lens having refractive power; the fifth lens having refractive power; the sixth lens having refractive power; and does not need other additional features and conditions.

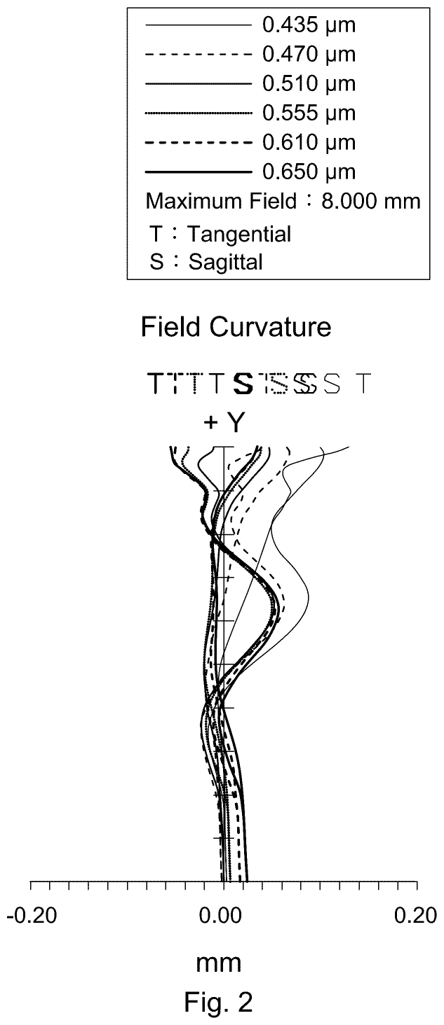

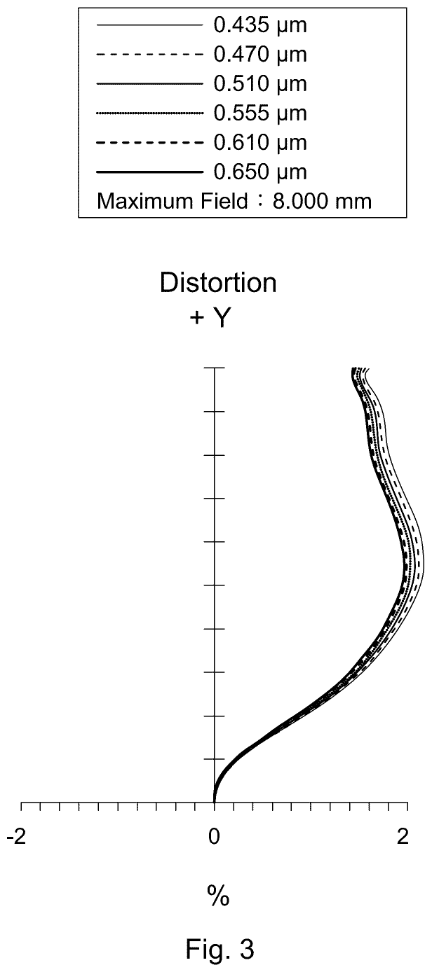

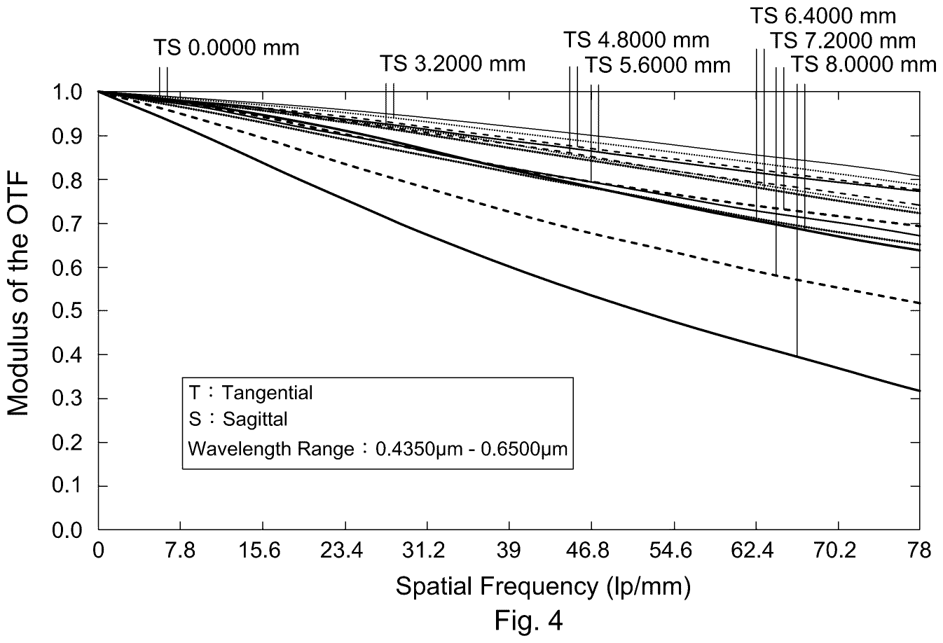

In addition, the lens assembly 1 of the first embodiment can meet the requirements of optical performance as seen in FIGS. 2-4. It can be seen from FIG. 2 that the field curvature of tangential direction and sagittal direction in the lens assembly 1 of the first embodiment ranges from −0.06 mm to 0.14 mm. It can be seen from FIG. 3 that the distortion in the lens assembly 1 of the first embodiment ranges from 0% to 2.2%. It can be seen from FIG. 4 that the modulation transfer function of tangential direction and sagittal direction in the lens assembly 1 of the first embodiment ranges from 0.32 to 1.0. It is obvious that the field curvature and the distortion of the lens assembly 1 of the first embodiment can be corrected effectively, and the resolution of the lens assembly 1 of the first embodiment can meet the requirement. Therefore, the lens assembly 1 of the first embodiment is capable of good optical performance. The lens assembly 1 satisfies at least one of the conditions (1)-(19) as well as the refractive power and surface shape of Table 1 and Table 2, which is a preferred embodiment of the present invention.

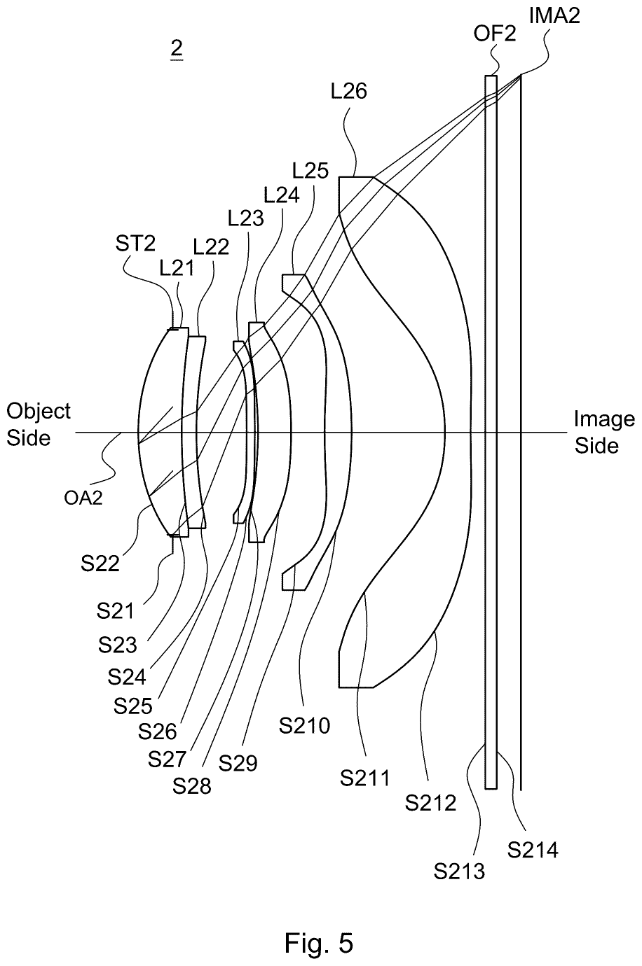

A detailed description of a lens assembly in accordance with a second embodiment of the invention is as follows. Referring to FIG. 5, the lens assembly 2 includes a stop ST2, a first lens L21, a second lens L22, a third lens L23, a fourth lens L24, a fifth lens L25, a sixth lens L26, and an optical filter OF2, all of which are arranged in order from an object side to an image side along an optical axis OA2. In operation, the light from the object side is imaged on an image plane IMA2.

According to the foregoing, wherein: the image side surface S24 of the second lens L22 is an aspheric surface; the third lens L23 is a meniscus lens with positive refractive power, wherein the object side surface S25 is a concave surface and the image side surface S26 is a convex surface; the fourth lens L24 is a meniscus lens with negative refractive power, wherein the object side surface S27 is a concave surface; both of the object side surface S213 and image side surface S214 of the optical filter OF2 are plane surfaces; and with the above design of the lenses, stop ST2, and at least one of the conditions (1)-(16) satisfied, the lens assembly 2 can have an effective increased resolution and an effective corrected aberration.

The lens assembly 2 further satisfies at least one of the following conditions (18), (20), and (21):

$$3.7 < ( TTL / BFL ) - ( D 1 obj / BFL ) < 5.2 ; \qquad ( 18 )$$

$$3 mm \leq fE + f F \leq 6 mm ; \qquad ( 20 )$$

$$43 {mm}^{2} < fA \times D 1 obj < 49 {mm}^{2} ; \qquad ( 21 )$$

Table 4 shows the optical specification of the lens assembly 2 in FIG. 5.

TABLE 4
Effective Focal Length = 8.772 mm F-number = 1.8
Total Lens Length = 10.42 mm Field of View = 85.18 degrees

| | Radius of | | | | Effective | |
|---|---|---|---|---|---|---|
| Surface | Curvature | Thickness | | | Focal Length | |
| Number | (mm) | (mm) | Nd | Vd | (mm) | Remark |
| S21 | ∞ | −0.938 | | | | ST2 |
| S22 | 4.115 | 1.187 | 1.59 | 61.16 | 9.359 | L21 |
| S23 | 14.357 | 0.400 | 2.00 | 19.32 | −38.497 | L22 |
| S24 | 10.341 | 1.366 | | | | |
| S25 | −24.540 | 0.220 | 1.69 | 18.40 | 55.528 | L23 |
| S26 | −15.047 | 0.087 | | | | |
| S27 | −7.494 | 0.899 | 1.54 | 56.11 | −49.819 | L24 |
| S28 | −10.846 | 0.914 | | | | |
| S29 | 11.835 | 0.736 | 1.54 | 56.11 | 9.169 | L25 |
| S210 | −8.249 | 2.541 | | | | |
| S211 | −3.688 | 0.699 | 1.54 | 56.11 | −5.772 | L26 |
| S212 | 20.721 | 0.400 | | | | |
| S213 | ∞ | 0.310 | 1.52 | 64.19 | | OF2 |
| S214 | ∞ | 0.661 | | | | |

The definition of aspheric surface sag z of each aspheric lens in table 4 is the same as that of in Table 1, and is not described here again.

In the second embodiment, the conic constant k and the aspheric coefficients A, B, C, D, E, F, G of each aspheric lens are shown in Table 5.

TABLE 5

| Surface | | A | B | C | |
|---|---|---|---|---|---|
| Number | k | E | F | G | D |
| S22 | 3.16E−01 | 2.71E−05 | −2.52E−05 | 4.28E−05 | −1.26E−05 |
| | | 1.91E−06 | −2.59E−08 | −9.40E−09 | |
| S24 | 3.48E+00 | −9.83E−05 | 4.30E−04 | −2.75E−04 | 1.32E−04 |
| | | −3.95E−05 | 6.53E−06 | −4.62E−07 | |
| S25 | 1.34E+02 | 1.82E−02 | −2.13E−02 | 6.35E−03 | −1.38E−03 |
| | | 1.78E−04 | −7.28E−06 | −4.74E−07 | |
| S26 | −2.75E+02 | 3.33E−02 | −2.92E−02 | 8.47E−03 | −1.29E−03 |
| | | 5.76E−05 | 1.05E−05 | −1.17E−06 | |
| S27 | −4.60E−01 | 2.15E−02 | −1.65E−02 | 5.28E−03 | −5.03E−04 |
| | | −9.72E−05 | 2.61E−05 | −1.62E−06 | |
| S28 | −1.88E+02 | −3.17E−02 | 5.87E−03 | −9.88E−04 | 2.33E−07 |
| | | 4.97E−05 | −1.07E−05 | 7.42E−07 | |
| S29 | −2.61E+02 | 6.36E−03 | −6.42E−03 | 1.72E−03 | −3.24E−04 |
| | | 3.88E−05 | −2.63E−06 | 7.42E−08 | |
| S210 | 3.29E+00 | 1.72E−03 | −1.04E−03 | 4.58E−05 | 5.55E−07 |
| | | 7.14E−07 | −7.21E−08 | 1.80E−09 | |
| S211 | −4.83E+00 | −1.93E−02 | 1.69E−03 | −6.41E−05 | 1.59E−06 |
| | | −4.67E−08 | 1.30E−09 | −1.57E−11 | |
| S212 | −1.26E+02 | −7.32E−03 | 4.53E−04 | −1.25E−05 | −1.60E−07 |
| | | 1.94E−08 | −4.84E−10 | 4.21E−12 | |

Table 6 shows the parameters and condition values for conditions (1)-(16), (18), (20), and (21) in accordance with the second embodiment of the invention. It can be seen from Table 6 that the lens assembly 2 of the second embodiment satisfies the conditions (1)-(16), (18), (20), and (21).

TABLE 6

| | | | | | | | | |
|---|---|---|---|---|---|---|---|---|
| CT1 | 1.587 | mm | CT2 | 7.462 | mm | BFL | 1.371 | mm |
| D1obj | 4.95 | mm | fA | 9.359 | mm | fB | −38.497 | mm |
| fC | 55.528 | mm | fD | −49.819 | mm | fE | 9.169 | mm |
| fF | −5.772 | mm | TC12 | 0 | mm | T1 | 1.187 | mm |

| (f + TTL)/CT1 | 12.09 | | TTL/CT1 | 6.57 | (f + BFL)/CT1 | 6.39 | |
|---|---|---|---|---|---|---|---|
| fA × D1obj | 46.33 | mm² | (TTL + | 2.38 | D1obj + R11 | 9.06 | mm |

BFL)/D1obj

| | | | | | | | |
|---|---|---|---|---|---|---|---|
| f + CT2 | 16.23 | mm | (TTL/BFL) − | 3.99 | f × T1 | 10.41 | mm² |

(D1obj/BFL)

| | | | | | | | |
|---|---|---|---|---|---|---|---|
| fB + fC | 17.03 | mm | fA + fD | −40.46 | mm | f/(fA + fB) | −0.30 |

| | | | | | | |
|---|---|---|---|---|---|---|
| fE + fF | 3.40 | mm | CT2/CT1 | 4.70 | Vd4/Vd5 | 1.00 |

The lens assembly 2 can meet the basic operation requirements when it is modified to only satisfies at least one of the conditions (1)-(16), (18), (20), and (21); the first lens having positive refractive power, a convex surface facing the object side, and a concave surface facing the image side; the second lens having negative refractive power, a convex surface facing the object side, and a concave surface facing the image side; the third lens having refractive power; the fourth lens having refractive power; the fifth lens having refractive power; the sixth lens having refractive power; and does not need other additional features and conditions.

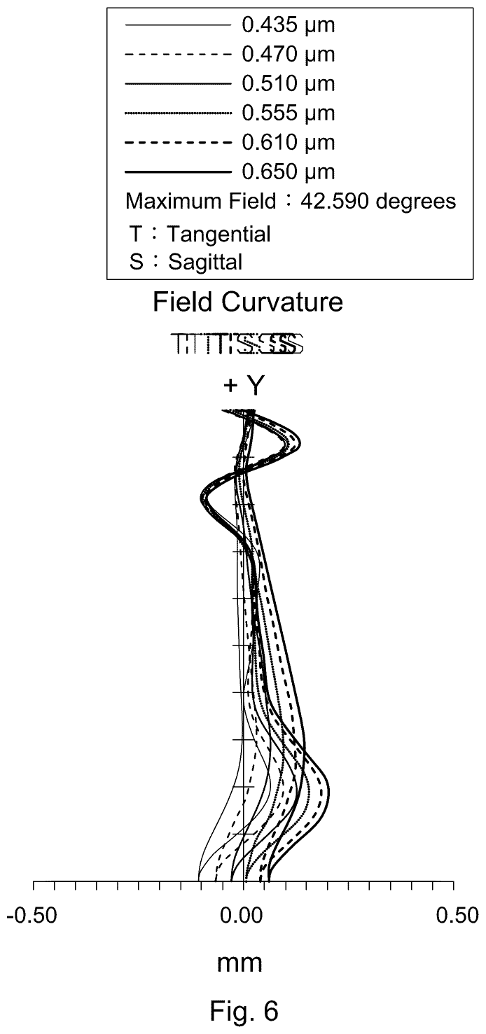

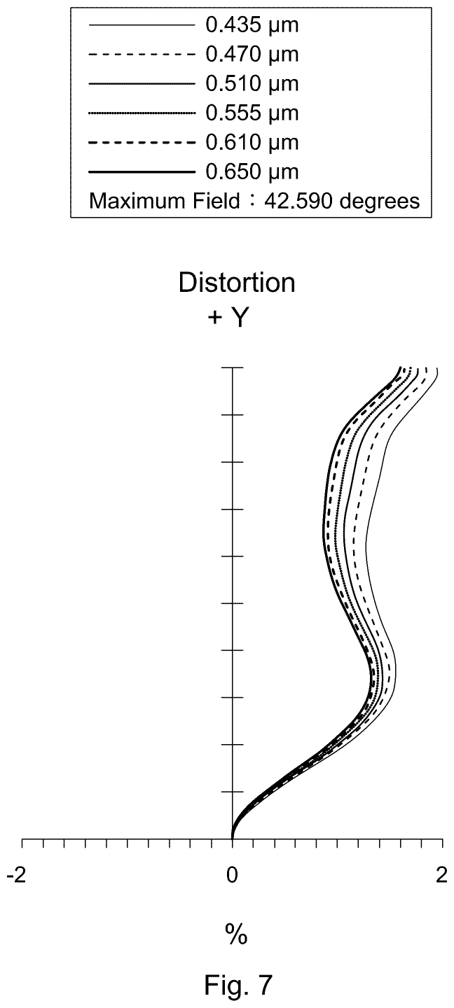

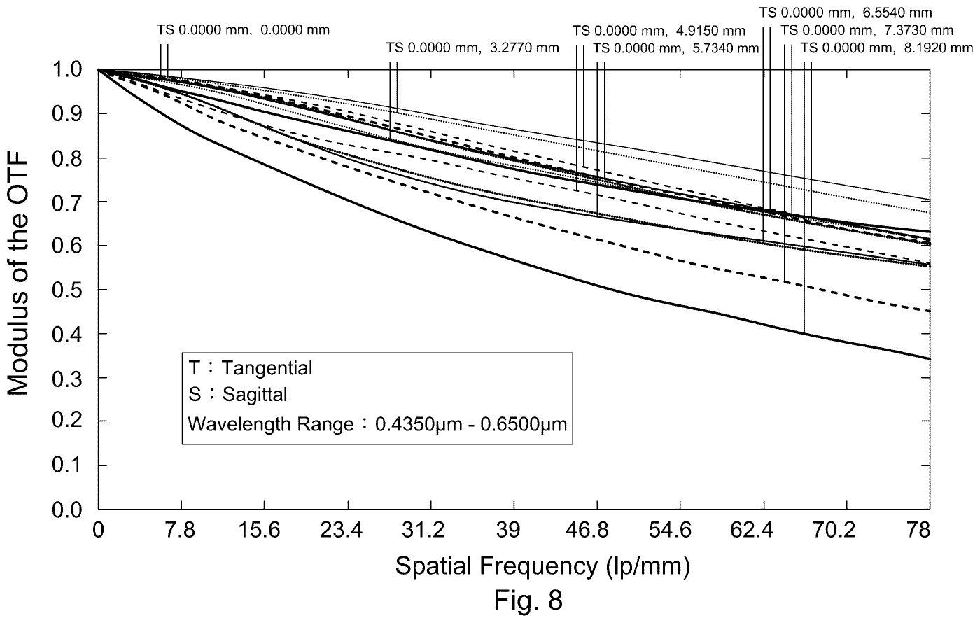

In addition, the lens assembly 2 of the second embodiment can meet the requirements of optical performance as seen in FIGS. 6-8. It can be seen from FIG. 6 that the field curvature of tangential direction and sagittal direction in the lens assembly 2 of the second embodiment ranges from −0.15 mm to 0.20 mm. It can be seen from FIG. 7 that the distortion in the lens assembly 2 of the second embodiment ranges from 0% to 2%. It can be seen from FIG. 8 that the modulation transfer function of tangential direction and sagittal direction in the lens assembly 2 of the second embodiment ranges from 0.34 to 1.0. It is obvious that the field curvature and the distortion of the lens assembly 2 of the second embodiment can be corrected effectively, and the resolution of the lens assembly 2 of the second embodiment can meet the requirement. Therefore, the lens assembly 2 of the second embodiment is capable of good optical performance. The lens assembly 2 satisfies at least one of the conditions (1)-(16), (18), (20), and (21) as well as the refractive power and surface shape of Table 4 and Table 5, which is a preferred embodiment of the present invention.

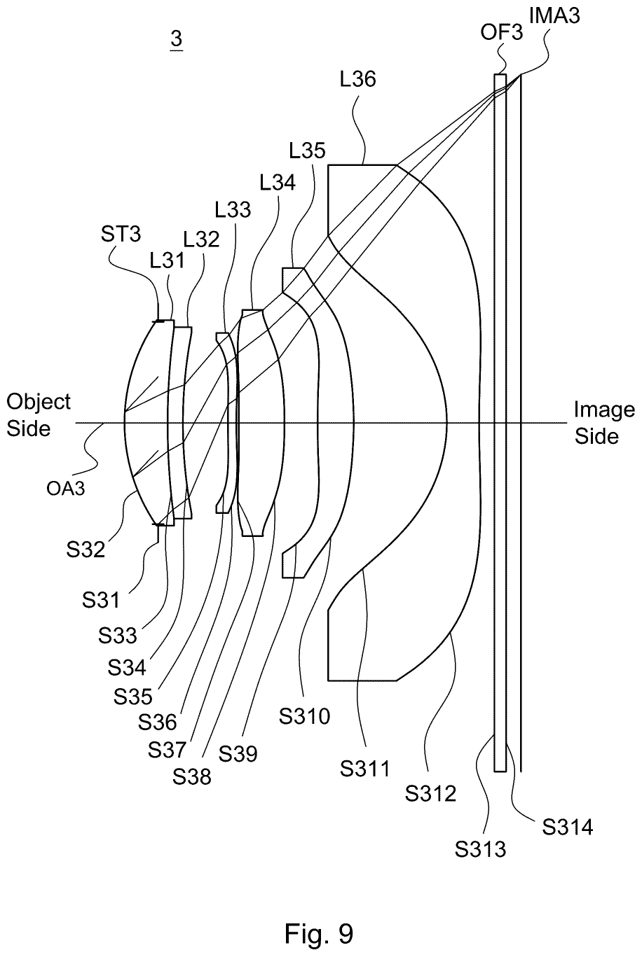

A detailed description of a lens assembly in accordance with a third embodiment of the invention is as follows. Referring to FIG. 9, the lens assembly 3 includes a stop ST3, a first lens L31, a second lens L32, a third lens L33, a fourth lens L34, a fifth lens L35, a sixth lens L36, and an optical filter OF3, all of which are arranged in order from an object side to an image side along an optical axis OA3. In operation, the light from the object side is imaged on an image plane IMA3.

According to the foregoing, wherein: the image side surface S34 of the second lens L32 is an aspheric surface; the third lens L33 is a meniscus lens with negative refractive power, wherein the object side surface S35 is a convex surface and the image side surface S36 is a concave surface; the fourth lens L34 is a biconvex lens with positive refractive power, wherein the object side surface S37 is a convex surface; both of the object side surface S313 and image side surface S314 of the optical filter OF3 are plane surfaces; and with the above design of the lenses, stop ST3, and at least one of the conditions (1)-(16) satisfied, the lens assembly 3 can have an effective increased resolution and an effective corrected aberration.

The lens assembly 3 further satisfies at least one of the following conditions (18), (19), (20), and (21):

$$3.7 < ( TTL / BFL ) - ( D 1 obj / BFL ) < 5.2 ; \qquad ( 18 )$$

$$4.1 < ( TTL / BFL ) - ( D 1 obj / BFL ) < 5.7 ; \qquad ( 19 )$$

$$3 mm \leq fE + f F \leq 6 mm ; \qquad ( 20 )$$

$$43 {mm}^{2} < fA \times D 1 obj < 49 {mm}^{2} ; \qquad ( 21 )$$

Table 7 shows the optical specification of the lens assembly 3 in FIG. 9.

TABLE 7
Effective Focal Length = 8.574 mm F-number = 1.75
Total Lens Length = 10.425 mm Field of View = 80.48 degrees

| | Radius of | | | | Effective | |
|---|---|---|---|---|---|---|
| Surface | Curvature | Thickness | | | Focal Length | |
| Number | (mm) | (mm) | Nd | Vd | (mm) | Remark |
| S31 | ∞ | −0.883 | | | | ST3 |
| S32 | 4.221 | 1.136 | 1.58 | 59.91 | 9.395 | L31 |
| S33 | 16.264 | 0.400 | 2.00 | 19.32 | −35.483 | L32 |
| S34 | 11.053 | 1.183 | | | | |
| S35 | 19.917 | 0.220 | 1.69 | 18.40 | −35.332 | L33 |
| S36 | 10.940 | 0.066 | | | | |
| S37 | 263.383 | 1.200 | 1.54 | 56.11 | 21.017 | L34 |
| S38 | −11.772 | 0.873 | | | | |
| S39 | 16.783 | 0.949 | 1.54 | 56.11 | 10.838 | L35 |
| S310 | −8.733 | 2.449 | | | | |
| S311 | −3.306 | 0.849 | 1.54 | 56.11 | −5.366 | L36 |
| S312 | 24.474 | 0.400 | | | | |
| S313 | ∞ | 0.310 | 1.52 | 64.19 | | OF3 |
| S314 | ∞ | 0.390 | | | | |

The definition of aspheric surface sag z of each aspheric lens in table 7 is the same as that of in Table 1, and is not described here again.

In the third embodiment, the conic constant k and the aspheric coefficients A, B, C, D, E, F, G of each aspheric lens are shown in Table 8.

TABLE 8

| Surface | | A | B | C | |
|---|---|---|---|---|---|
| Number | k | E | F | G | D |
| S32 | −1.35E−01 | 2.68E−04 | 1.96E−04 | 1.60E−05 | −2.32E−05 |
| | | 6.86E−06 | −7.95E−07 | 3.21E−08 | |
| S34 | 3.77E+00 | 7.18E−04 | −8.24E−04 | 5.24E−04 | −1.79E−04 |
| | | 3.25E−05 | −2.88E−06 | 7.31E−08 | |
| S35 | −7.88E+01 | −1.87E−02 | 4.44E−04 | −1.14E−03 | 1.33E−05 |
| | | 1.24E−04 | −2.98E−05 | 2.13E−06 | |
| S36 | 3.34E+00 | −2.35E−02 | 2.72E−03 | −1.18E−03 | 2.69E−04 |
| | | −1.53E−05 | −3.24E−06 | 3.88E−07 | |
| S37 | 9.48E+03 | −1.22E−02 | 2.28E−03 | 1.07E−03 | −4.93E−04 |
| | | 8.41E−05 | −6.56E−06 | 1.97E−07 | |
| S38 | −9.19E+01 | −1.97E−02 | 3.04E−03 | −5.80E−04 | 8.45E−05 |
| | | −2.20E−06 | −8.36E−07 | 7.79E−08 | |
| S39 | −2.78E+02 | 1.96E−03 | −4.09E−03 | 1.32E−03 | −3.12E−04 |
| | | 4.23E−05 | −3.03E−06 | 8.79E−08 | |
| S310 | −2.00E+00 | 1.48E−03 | −6.38E−04 | 3.97E−06 | −3.53E−06 |
| | | 4.69E−07 | 1.37E−08 | −1.56E−09 | |
| S311 | −5.45E−01 | −2.07E−04 | −7.60E−06 | −3.25E−05 | 4.04E−06 |
| | | −7.58E−08 | −3.05E−09 | 9.29E−11 | |
| S312 | −5.86E+02 | −4.15E−04 | −1.58E−04 | 1.07E−05 | −3.88E−07 |
| | | 8.00E−09 | −1.01E−10 | 6.55E−13 | |

Table 9 shows the parameters and condition values for conditions (1)-(16), (18), (19), (20), and (21) in accordance with the third embodiment of the invention. It can be seen from Table 9 that the lens assembly 3 of the third embodiment satisfies the conditions (1)-(16), (18), (19), (20), and (21).

TABLE 9

| | | | | | | | | |
|---|---|---|---|---|---|---|---|---|
| CT1 | 1.536 | mm | CT2 | 7.79 | mm | BFL | 1.1 | mm |
| D1obj | 4.974 | mm | fA | 9.395 | mm | fB | −35.483 | mm |
| fC | −35.332 | mm | fD | 21.017 | mm | fE | 10.838 | mm |
| fF | −5.366 | mm | TC12 | 0 | mm | T1 | 1.136 | mm |

| (f + TTL)/CT1 | 12.37 | | TTL/CT1 | 6.79 | (f + BFL)/CT1 | 6.30 | |
|---|---|---|---|---|---|---|---|
| fA × D1obj | 46.73 | mm² | (TTL + | 2.32 | D1obj + R11 | 9.2 | mm |

BFL)/D1obj

| | | | | | | | |
|---|---|---|---|---|---|---|---|
| f + CT2 | 16.36 | mm | (TTL/BFL) − | 4.96 | f × T1 | 9.74 | mm² |

(D1obj/BFL)

| | | | | | | | |
|---|---|---|---|---|---|---|---|
| fB + fC | −70.82 | mm | fA + fD | 30.41 | mm | f/(fA + fB) | −0.33 |

| | | | | | | |
|---|---|---|---|---|---|---|
| fE + fF | 5.47 | mm | CT2/CT1 | 5.07 | Vd4/Vd5 | 1.00 |

The lens assembly 3 can meet the basic operation requirements when it is modified to only satisfies at least one of the conditions (1)-(16), (18), (19), (20), and (21); the first lens having positive refractive power, a convex surface facing the object side, and a concave surface facing the image side; the second lens having negative refractive power, a convex surface facing the object side, and a concave surface facing the image side; the third lens having refractive power; the fourth lens having refractive power; the fifth lens having refractive power; the sixth lens having refractive power; and does not need other additional features and conditions.

In addition, the field curvature (illustration omitted) and distortion (illustration omitted) of the lens assembly 3 of the third embodiment can also be effectively corrected, and the resolution can meet the requirement. Therefore, the lens assembly 3 of the third embodiment is capable of good optical performance. The lens assembly 3 of the third embodiment satisfies at least one of the conditions (1)-(16), (18), (19), (20), and (21) as well as the refractive power and surface shape of Table 7 and Table 8, which is a preferred embodiment of the present invention.

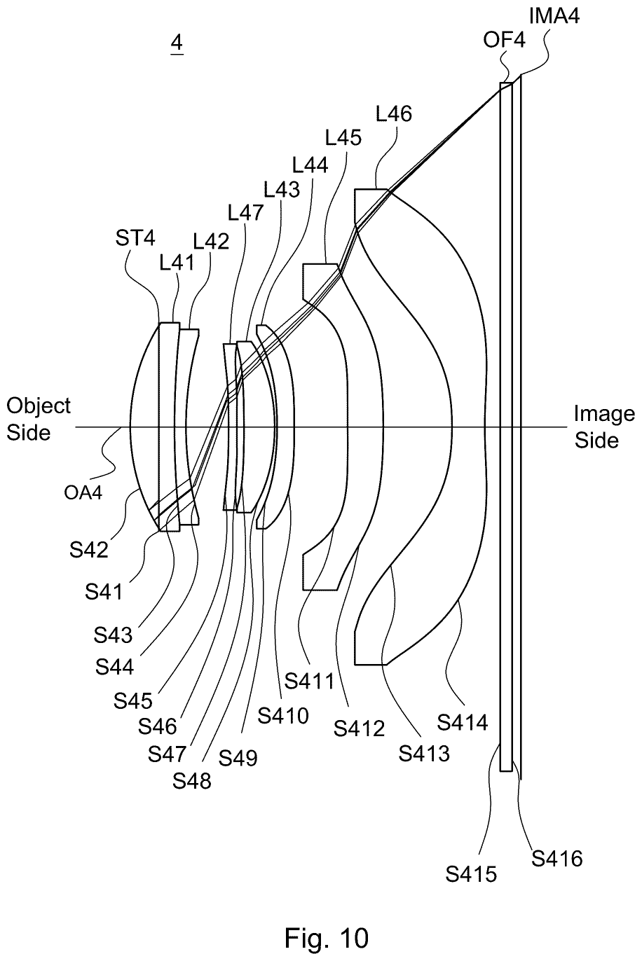

A detailed description of a lens assembly in accordance with a fourth embodiment of the invention is as follows. Referring to FIG. 10, the lens assembly 4 includes a stop ST4, a first lens L41, a second lens L42, a seventh lens L47, a third lens L43, a fourth lens L44, a fifth lens L45, a sixth lens L46, and an optical filter OF4, all of which are arranged in order from an object side to an image side along an optical axis OA4. In operation, the light from the object side is imaged on an image plane IMA4.

According to the foregoing, wherein: the image side surface S44 of the second lens L42 is a spherical surface; the seventh lens L47 is disposed between the second lens L42 and the third lens L43, wherein the seventh lens L47 is a biconcave lens with negative refractive power, the object side surface S45 is a concave surface, the image side surface S46 is a concave surface, and both of the object side surface S45 and image side surface S46 are aspheric surfaces; the third lens L43 is a meniscus lens with positive refractive power, wherein the object side surface S47 is a concave surface and the image side surface S48 is a convex surface; the fourth lens L44 is a meniscus lens with negative refractive power, wherein the object side surface S49 is a concave surface; both of the object side surface S415 and image side surface S416 of the optical filter OF4 are plane surfaces; and with the above design of the lenses, stop ST4, and at least one of the conditions (1)-(16) satisfied, the lens assembly 4 can have an effective increased resolution and an effective corrected aberration.

The lens assembly 4 further satisfies at least one of the following conditions (17), (19), and (20):

$$27 {mm}^{2} < fA \times D 1 obj < 33 {mm}^{2} ; \qquad ( 17 )$$

$$4.1 < ( TTL / BFL ) - ( D 1 obj / BFL ) < 5.7 ; \qquad ( 19 )$$

$$3 mm \leq fE + f F \leq 6 mm ; \qquad ( 20 )$$

Table 10 shows the optical specification of the lens assembly 4 in FIG. 10.

TABLE 10
Effective Focal Length = 8.499 mm F-number = 1.69
Total Lens Length = 10.153 mm Field of View = 86.53 degrees

| | Radius of | | | | Effective | |
|---|---|---|---|---|---|---|
| Surface | Curvature | Thickness | | | Focal Length | |
| Number | (mm) | (mm) | Nd | Vd | (mm) | Remark |
| S41 | ∞ | −0.744 | | | | ST4 |
| S42 | 4.405 | 1.149 | 1.88 | 37.20 | 6.132 | L41 |
| S43 | 20.204 | 0.299 | 2.00 | 19.32 | −11.682 | L42 |
| S44 | 7.398 | 1.108 | | | | |
| S45 | −49.908 | 0.216 | 1.67 | 19.24 | −51.472 | L47 |
| S46 | 115.987 | 0.185 | | | | |
| S47 | −25.157 | 0.801 | 1.53 | 56.11 | 7.341 | L43 |
| S48 | −3.446 | 0.060 | | | | |
| S49 | −6.368 | 0.446 | 1.62 | 25.92 | −13.734 | L44 |
| S410 | −26.017 | 1.385 | | | | |
| S411 | 64.674 | 0.927 | 1.67 | 19.24 | 18.233 | L45 |
| S412 | −15.182 | 1.787 | | | | |
| S413 | −5.496 | 0.851 | 1.62 | 25.92 | −5.718 | L46 |
| S414 | 10.547 | 0.400 | | | | |
| S415 | ∞ | 0.310 | 1.52 | 64.19 | | OF4 |
| S416 | ∞ | 0.230 | | | | |

The definition of aspheric surface sag z of each aspheric lens in table 10 is the same as that of in Table 1, and is not described here again.

In the fourth embodiment, the conic constant k and the aspheric coefficients A, B, C, D, E, F, G of each aspheric lens are shown in Table 11.

TABLE 11

| Surface | | A | B | C | |
|---|---|---|---|---|---|
| Number | k | E | F | G | D |
| S42 | −7.70E−01 | 1.37E−03 | −7.11E−05 | 9.70E−05 | −3.47E−05 |
| | | 6.77E−06 | −6.63E−07 | 2.60E−08 | |
| S45 | −1.34E+03 | −1.94E−02 | 2.69E−04 | 1.39E−03 | 4.98E−04 |
| | | −3.69E−04 | 6.66E−05 | −3.91E−06 | |
| S46 | 3.31E+03 | −1.63E−02 | −1.45E−03 | 9.54E−04 | 1.56E−03 |
| | | −7.52E−04 | 1.27E−04 | −7.77E−06 | |
| S47 | −1.14E+03 | −6.56E−03 | −3.97E−03 | 8.01E−04 | 2.31E−04 |
| | | −4.05E−05 | −1.55E−05 | 2.68E−06 | |
| S48 | −1.98E+01 | −1.84E−02 | 2.11E−05 | 2.11E−04 | 1.47E−05 |
| | | 8.09E−07 | −6.69E−06 | 1.02E−06 | |
| S49 | −8.17E+01 | −2.46E−02 | 2.21E−03 | 3.99E−04 | −8.02E−05 |
| | | −2.38E−05 | 6.28E−06 | −3.38E−07 | |
| S410 | 9.65E+01 | −2.29E−02 | 3.61E−03 | −4.35E−04 | −1.78E−05 |
| | | 5.32E−06 | 2.11E−07 | −8.90E−08 | |
| S411 | 4.35E+02 | −1.04E−02 | −2.93E−04 | −6.78E−06 | −9.27E−06 |
| | | 3.67E−06 | −5.32E−07 | 2.50E−08 | |
| S412 | 6.60E+00 | −5.21E−03 | −2.88E−04 | 2.49E−05 | −2.87E−08 |
| | | 3.55E−07 | −3.51E−08 | 8.82E−10 | |
| S413 | 5.08E−02 | −1.52E−02 | 1.64E−03 | −7.78E−05 | 2.17E−06 |
| | | −7.62E−09 | −1.48E−09 | 3.09E−11 | |
| S414 | −7.55E+01 | −8.44E−03 | 5.89E−04 | −2.30E−05 | 5.63E−08 |
| | | 2.72E−08 | −9.40E−10 | 1.06E−11 | |

Table 12 shows the parameters and condition values for conditions (1)-(16), (17), (19), and (20) in accordance with the fourth embodiment of the invention. It can be seen from Table 12 that the lens assembly 4 of the fourth embodiment satisfies the conditions (1)-(16), (17), (19), and (20).

TABLE 12

| | | | | | | | | |
|---|---|---|---|---|---|---|---|---|
| CT1 | 1.448 | mm | CT2 | 7.766 | mm | BFL | 0.94 | mm |
| D1obj | 5 | mm | fA | 6.132 | mm | fB | −11.682 | mm |
| fC | −51.472 | mm | fD | 7.341 | mm | fE | −13.734 | mm |
| fF | 18.233 | mm | TC12 | 0 | mm | T1 | 1.149 | mm |

| (f + TTL)/CT1 | 12.88 | | TTL/CT1 | 7.01 | (f + BFL)/CT1 | 6.52 | |
|---|---|---|---|---|---|---|---|
| fA × D1obj | 30.66 | mm² | (TTL + | 2.22 | D1obj + R11 | 9.40 | mm |

BFL)/D1obj

| | | | | | | | |
|---|---|---|---|---|---|---|---|
| f + CT2 | 16.27 | mm | (TTL/BFL) − | 5.48 | f × T1 | 9.77 | mm² |

(D1obj/BFL)

| | | | | | | | |
|---|---|---|---|---|---|---|---|
| fB + fC | −63.15 | mm | fA + fD | 13.47 | mm | f/(fA + fB) | −1.53 |

| | | | | | | |
|---|---|---|---|---|---|---|
| fE + fF | 4.50 | mm | CT2/CT1 | 5.36 | Vd4/Vd5 | 2.16 |

The lens assembly 4 can meet the basic operation requirements when it is modified to only satisfies at least one of the conditions (1)-(16), (17), (19), and (20); the first lens having positive refractive power, a convex surface facing the object side, and a concave surface facing the image side; the second lens having negative refractive power, a convex surface facing the object side, and a concave surface facing the image side; the seventh lens having negative refractive power; the third lens having refractive power; the fourth lens having refractive power; the fifth lens having refractive power; the sixth lens having refractive power; and does not need other additional features and conditions.

In addition, the field curvature (illustration omitted) and distortion (illustration omitted) of the lens assembly 4 of the fourth embodiment can also be effectively corrected, and the resolution can meet the requirement. Therefore, the lens assembly 4 of the fourth embodiment is capable of good optical performance. The lens assembly 4 of the fourth embodiment satisfies at least one of the conditions (1)-(16), (17), (19), and (20) as well as the refractive power and surface shape of Table 10 and Table 11, which is a preferred embodiment of the present invention.

Referring to Table 13, Table 14, Table 16, Table 17, Table 19, Table 20, Table 22, and Table 23, wherein Table 13, Table 16, Table 19, and Table 22 show optical specification in accordance with a fifth, a sixth, a seventh, and an eighth embodiments of the invention, respectively, and Table 14, Table 17, Table 20, and Table 23 show aspheric coefficients of each aspheric lens in Table 13, Table 16, Table 19, and Table 22, respectively.

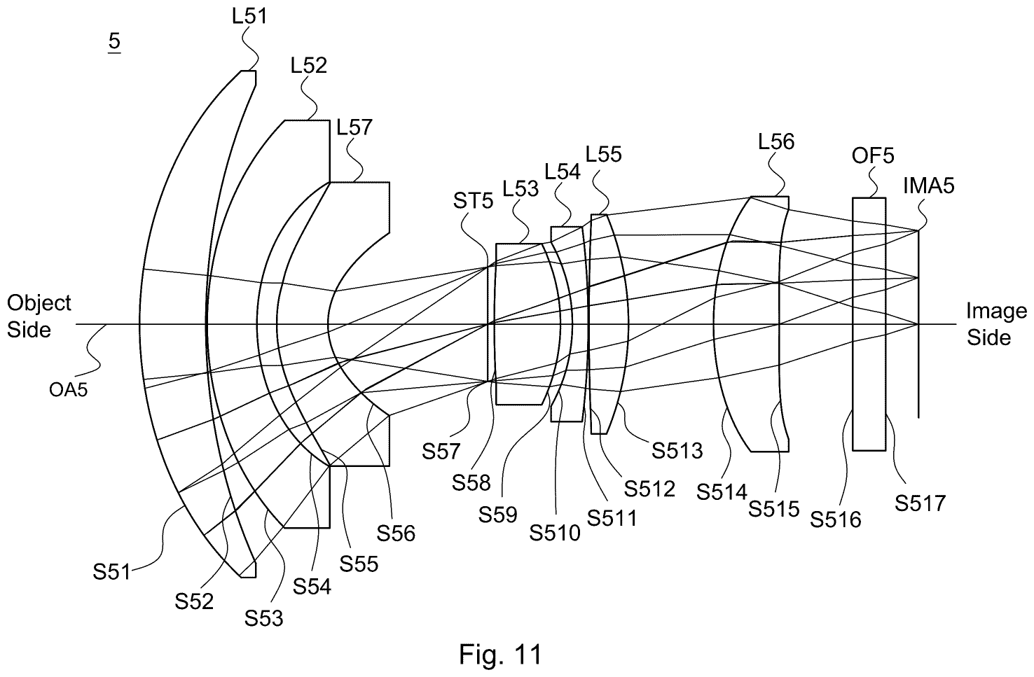

FIGS. 11, 16, 21, 22 are lens layout and optical path diagrams of the lens assemblies in accordance with the fifth, sixth, seventh, and eighth embodiments of the invention, respectively.

The first lenses L51, L61, L71, L81 are meniscus lenses with positive refractive power, wherein the object side surfaces S51, S61, S71, S81 are convex surfaces, the image side surfaces S52, S62, S72, S82 are concave surfaces, and both of the object side surfaces S51, S61, S71, S81 and image side surfaces S52, S62, S72, S82 are spherical surfaces.

The second lenses L52, L62, L72, L82 are meniscus lens with negative refractive power, wherein the object side surfaces S53, S63, S73, S83 are convex surfaces, the image side surfaces S54, S64, S74, S84 are concave surfaces, and both of the object side surfaces S53, S63, S73, S83 and image side surfaces S54, S64, S74, S84 are spherical surfaces.

The seventh lenses L57, L67, L77, L87 are meniscus lenses with negative refractive power, wherein the object side surfaces S55, S65, S75, S85 are convex surfaces and the image side surfaces are S56, S66, S76, S86 are concave surfaces.

The third lenses L53, L63, L73, L83 are with positive refractive power, wherein the image side surfaces S59, S69, S79, S88 are convex surfaces and both of the object side surfaces S58, S68, S78, S87 and image side surfaces S59, S69, S79, S88 are spherical surfaces.

The fourth lenses L54, L64, L74, L84 are meniscus lenses, wherein the object side surfaces S510, S610, S710, S810 are concave surfaces and the image side surfaces S511, S611, S711, S811 are convex surfaces.

The fifth lenses L55, L65, L75, L85 are biconvex lenses with positive refractive power, wherein the object side surfaces S512, S612, S712, S812 are convex surfaces, the image side surfaces S513, S613, S713, S813 are convex surfaces, and both of the object side surfaces S512, S612, S712, S812 and image side surfaces S513, S613, S713, S813 are spherical surfaces.

The sixth lenses L56, L66, L76, L86 are biconvex lenses with positive refractive power, wherein the object side surfaces S514, S614, S714, S814 are convex surfaces, the image side surfaces S515, S615, S715, S815 are convex surfaces, and both of the object side surfaces S514, S614, S714, S814 and image side surfaces S515, S615, S715, S815 are aspheric surfaces.

In addition, the lens assemblies 5, 6, 7, and 8 satisfy at least one of the following conditions (11), (15)-(16), and (22)-(30):

$$- 100 mm \leq fB + f C \leq 50 mm ; \qquad ( 11 )$$

$$1 \leq CT 2 / CT 1 \leq 7 ; \qquad ( 15 )$$

$$0.2 \leq Vd 4 / Vd 5 \leq 3.1 ; \qquad ( 16 )$$

$$1.56 \leq fG / f \leq 1.94 ; \qquad ( 22 )$$

$$0.8 \leq \vert fD / fE \vert \leq 1.2 ; \qquad ( 23 )$$

$$0.4 \leq \vert fF / fE \vert \leq 1.3 ; \qquad ( 24 )$$

$$4.8 \leq R 12 / T 1 \leq 6.2 ; \qquad ( 25 )$$

$$- 4.9 \leq R 62 / T 6 \leq - 4.3 ; \qquad ( 26 )$$

$$3 \leq \vert R 41 / R 42 \vert \leq 5.7 ; \qquad ( 27 )$$

$$0.6 \leq ( R 12 - R 11 ) / ( R 21 - R 22 ) \leq 2.2 ; \qquad ( 28 )$$

$$- 0.27 \leq ( R 11 - R 12 ) / TTL \leq - 0 \text{.16} ; \qquad ( 29 )$$

$$5 \leq TTL / BFL \leq 10 ; \qquad ( 30 )$$

wherein: fB is an effective focal length of the lenses L52, L52, L52, L52 second closest to the object side for the fifth to eighth embodiments; fC is an effective focal length of the lenses L57, L67, L77, L87 third closest to the object side for the fifth to eighth embodiments; CT1 is an interval from the object side surfaces S51, S61, S71, S81 of the first lenses L51, L61, L71, L81 to the image side surfaces S54, S64, S74, S74 of the second lenses L52, L62, L72, L72 along the optical axes OA5, OA6, OA7, OA8 for the fifth to eighth embodiments; CT2 is an interval from the image side surfaces S54, S64, S74, S84 of the second lenses L52, L62, L72, L82 to the image side surfaces S515, S615, S715, S815 of the sixth lenses L56, L66, L76, L86 along the optical axes OA5, OA6, OA7, OA8 for the fifth to eighth embodiments; f is an effective focal length of the lens assemblies 5, 6, 7, 8 for the fifth to eighth embodiments; fD is an effective focal length of the lenses L53, L63, L73, L83 fourth closest to the object side for the fifth to eighth embodiments; fE is an effective focal length of the lenses L54, L64, L74, L84 fifth closest to the object side for the fifth to eighth embodiments; fF is an effective focal length of the lenses L55, L65, L75, L85 sixth closest to the object side for the fifth to eighth embodiments; fG is an effective focal length of the lenses L56, L66, L76, L86 seventh closest to the object side for the fifth to eighth embodiments; R11 is a radius of curvature of the object side surfaces S51, S61, S71, S81 of the first lenses L51, L61, L71, L81 for the fifth to eighth embodiments; R12 is a radius of curvature of the image side surfaces S52, S62, S72, S82 of the first lenses L51, L61, L71, L81 for the fifth to eighth embodiments; R21 is a radius of curvature of the object side surfaces S53, S63, S73, S83 of the second lenses L52, L62, L72, L82 for the fifth to eighth embodiments; R22 is a radius of curvature of the image side surfaces S54, S64, S74, S84 of the second lenses L52, L62, L72, L82 for the fifth to eighth embodiments; R41 is a radius of curvature of the object side surfaces S58, S68, S78, S87 of the lenses L53, L63, L73, L83 fourth closest to the object side for the fifth to eighth embodiments; R42 is a radius of curvature of the image side surfaces S59, S69, S79, S88 of the lenses L53, L63, L73, L83 fourth closest to the object side for the fifth to eighth embodiments; R62 is a radius of curvature of the image side surfaces S513, S613, S713, S813 of the lenses L55, L65, L75, L85 sixth closest to the object side for the fifth to eighth embodiments; T1 is an interval from the object side surfaces S51, S61, S71, S81 of the first lenses L51, L61, L71, L81 to the image side surfaces S52, S62, S72, S82 of the first lenses L51, L61, L71, L81 along the optical axes OA5, OA6, OA7, OA8 for the fifth to eighth embodiments; T6 is an interval from the object side surfaces S512, S612, S712, S812 of the lenses L55, L65, L75, L85 sixth closest to the object side to the image side surfaces S513, S613, S713, S813 of the lenses L55, L65, L75, L85 sixth closest to the object side along the optical axes OA5, OA6, OA7, OA8 for the fifth to eighth embodiments; TTL is an interval from the object side surfaces S51, S61, S71, S81 of the first lenses L51, L61, L71, L81 to the image planes IMA5, IMA6, IMA7, IMA8 along the optical axes OA5, OA6, OA7, OA8 for the fifth to eighth embodiments; BFL is an interval from the image side surfaces S515, S615, S715, S819 of the lenses L56, L66, L76, L89 closest to the image side to the image planes IMA5, IMA6, IMA7, IMA8 along the optical axes OA5, OA6, OA7, OA8 for the fifth to eighth embodiments; Vd4 is an Abbe number of the lenses L53, L63, L73, L83 fourth closest to the object side for the fifth to eighth embodiments; and Vd5 is an Abbe number of the lenses L54, L64, L74, L84 fifth closest to the object side for the fifth to eighth embodiments. Making lens assemblies 5, 6, 7, and 8 having increased resolution effectively, decreased distortion effectively, and corrected aberration effectively.

When the condition (22): 1.56≤fG/f≤1.94 is satisfied, the total lens length of the lens assembly can be decreased effectively. When the condition (23): 0.8≤|fD/fE|≤1.2 is satisfied, the light collection ability can be increased effectively. When the condition (24): 0.4≤|fF/fE|≤1.3 is satisfied, the distortion can be decreased effectively. When the condition (25): 4.8≤R12/T1≤6.2 is satisfied, the distortion can be decreased effectively. When the condition (26): −4.9<R62/T6≤−4.3 is satisfied, the field curvature can be decreased effectively. When the condition (27): 3≤|R41/R42|≤5.7 is satisfied, the field curvature can be decreased effectively. When the condition (28): 0.6≤(R12−R11)/(R21−R22)≤2.2 is satisfied, the field curvature can be decreased effectively. When the condition (29): −0.27≤(R11−R12)/TTL≤−0.16 is satisfied, the total lens length of the lens assembly can be decreased effectively. When the condition (30): 5≤TTL/BFL≤10 is satisfied, the back focal length can be controlled effectively to improve production yield. When the condition (16): 0.2≤Vd4/Vd5≤3.1 is satisfied, the chromatic aberration can be corrected effectively and resolution can be increased effectively. The distortion can be decreased effectively and the image deformation can be reduced effectively when the second lens has a convex surface facing the object side, the third lens is with negative refractive power and includes a concave surface facing the image side, the fifth lens has a convex surface facing the image side, the sixth lens is with positive refractive power and includes a convex surface facing the object side or image side, and the seventh lens includes a convex surface facing the object side or image side.

A detailed description of a lens assembly in accordance with a fifth embodiment of the invention is as follows. Referring to FIG. 11, the lens assembly 5 includes a first lens L51, a second lens L52, a seventh lens L57, a stop ST5, a third lens L53, a fourth lens L54, a fifth lens L55, a sixth lens L56, and an optical filter OF5, all of which are arranged in order from an object side to an image side along an optical axis OA5. In operation, the light from the object side is imaged on an image plane IMA5.

According to the foregoing, wherein: the object side surface S55 and the image side surface S56 of the seventh lens L57 are aspheric surfaces; the third lens L53 is a biconvex lens, wherein the object side surface S58 is a convex surface; the fourth lens L54 is with negative refractive power, wherein both of the object side surface S510 and image side surface S511 are spherical surfaces; both of the object side surface S516 and image side surface S517 of the optical filter OF5 are plane surfaces; and with the above design of the lenses, stop ST5, and at least one of the conditions (11), (15)-(16), and (22)-(30) satisfied, the lens assembly 5 can have an effective increased resolution, an effective decreased distortion, and an effective corrected aberration.

Table 13 shows the optical specification of the lens assembly 5 in FIG. 11.

TABLE 13
Effective Focal Length = 11.00 mm F-number = 2.05
Total Lens Length = 47.23 mm Field of View = 44.45 degrees

| | Radius of | | | | Effective | |
|---|---|---|---|---|---|---|
| Surface | Curvature | Thickness | | | Focal Length | |
| Number | (mm) | (mm) | Nd | Vd | (mm) | Remark |
| S51 | 14.82 | 4.01 | 1.82 | 46.55 | 42.08 | L51 |
| S52 | 22.75 | 0.08 | | | | |
| S53 | 12.30 | 3.02 | 1.60 | 65.46 | −39.53 | L52 |
| S54 | 7.37 | 1.21 | | | | |
| S55 | 5.77 | 3.10 | 1.54 | 56.12 | −15.49 | L57 |
| S56 | 2.77 | 9.68 | | | | |
| S57 | ∞ | 0.41 | | | | ST5 |
| S58 | 39.46 | 4.00 | 1.50 | 81.61 | 12.27 | L53 |
| S59 | −7.00 | 0.73 | | | | |
| S510 | −6.50 | 0.96 | 1.74 | 28.30 | −11.42 | L54 |
| S511 | −28.76 | 0.04 | | | | |
| S512 | 92.93 | 2.40 | 1.71 | 53.83 | 13.65 | L55 |
| S513 | −10.83 | 5.15 | | | | |
| S514 | 10.37 | 3.98 | 1.54 | 56.12 | 18.11 | L56 |
| S515 | −143.10 | 4.45 | | | | |
| S516 | ∞ | 2.00 | 1.52 | 54.52 | | OF5 |
| S517 | ∞ | 2.00 | | | | |

The aspheric surface sag z of each lens in table 13 can be calculated by the following formula:

$$z = c {h}^{2} / \{ 1 + {[ 1 - ( k + 1 ) {c}^{2} {h}^{2} ]}^{1 / 2} \} + A {h}^{4} + B {h}^{6} + C {h}^{8} + D {h}^{10} + E {h}^{12} + F {h}^{14}$$

where c is curvature, h is the vertical distance from the lens surface to the optical axis, k is conic constant and A, B, C, D, E, and F are aspheric coefficients.

In the fifth embodiment, the conic constant k and the aspheric coefficients A, B, C, D, E, F of each aspheric lens are shown in Table 14.

TABLE 14

| Surface | | A | B | | |
|---|---|---|---|---|---|
| Number | k | E | F | C | D |
| S55 | −7.11E−01 | 0.00E+00 | −2.76E−04 | −6.77E−06 | −1.20E−07 |
| | | 5.03E−09 | −4.91E−11 | | |
| S56 | −1.01E+00 | 0.00E+00 | 1.24E−03 | −1.90E−05 | −1.67E−06 |
| | | 1.78E−07 | −4.19E−09 | | |
| S514 | 3.79E−01 | 0.00E+00 | 1.02E−04 | 1.87E−06 | 5.68E−09 |
| | | −1.63E−10 | −4.23E−12 | | |
| S515 | 0.00E+00 | 0.00E+00 | 6.80E−04 | −8.95E−07 | 3.05E−07 |
| | | −7.51E−09 | 4.48E−11 | | |

Table 15 shows the parameters and condition values for conditions (11), (15)-(16), and (22)-(30) in accordance with the fifth embodiment of the invention. It can be seen from Table 15 that the lens assembly 5 of the fifth embodiment satisfies the conditions (11), (15)-(16), and (22)-(30).

TABLE 15

| T1 | 4.01 mm | T6 | 2.40 | mm | BFL | 8.45 mm |
|---|---|---|---|---|---|---|
| CT1 | 7.11 mm | CT2 | 31.67 | mm | | |
| f7/f | 1.65 | \|f4/f5\| | 1.07 | | \|f6/f5\| | 1.20 |
| R12/T1 | 5.67 | R62/T6 | −4.51 | | \|R41/R42\| | 5.64 |
| (R12 − R11)/ | 1.61 | (R11 − R12)/ | −0.17 | | TTL/BFL | 5.59 |
| (R21 − R22) | | TTL | | | | |
| Vd4/Vd5 | 2.88 | fB + fC | −55.02 | mm | CT2/CT1 | 4.45 |

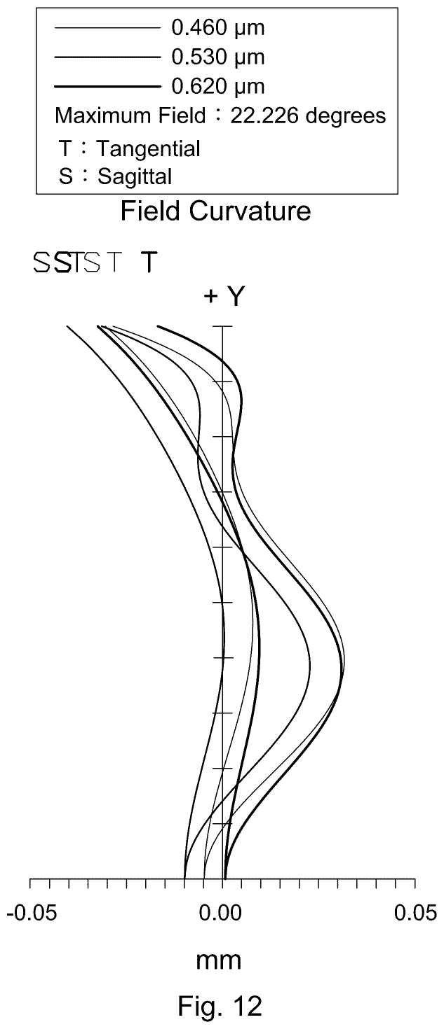

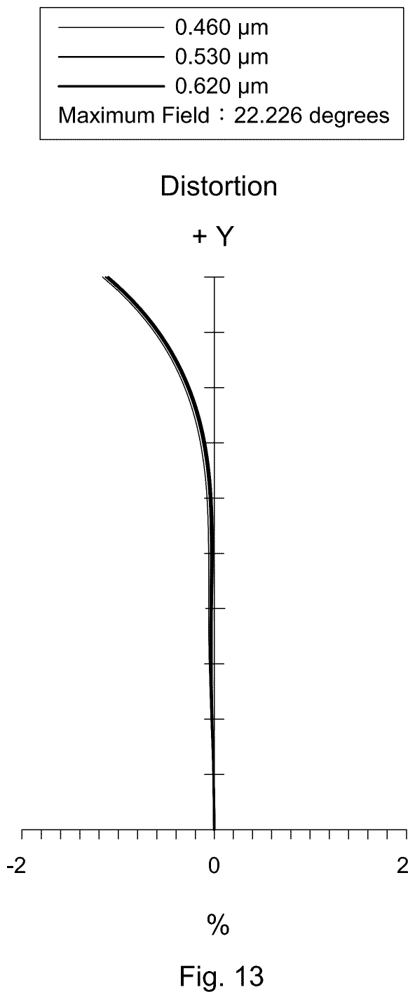

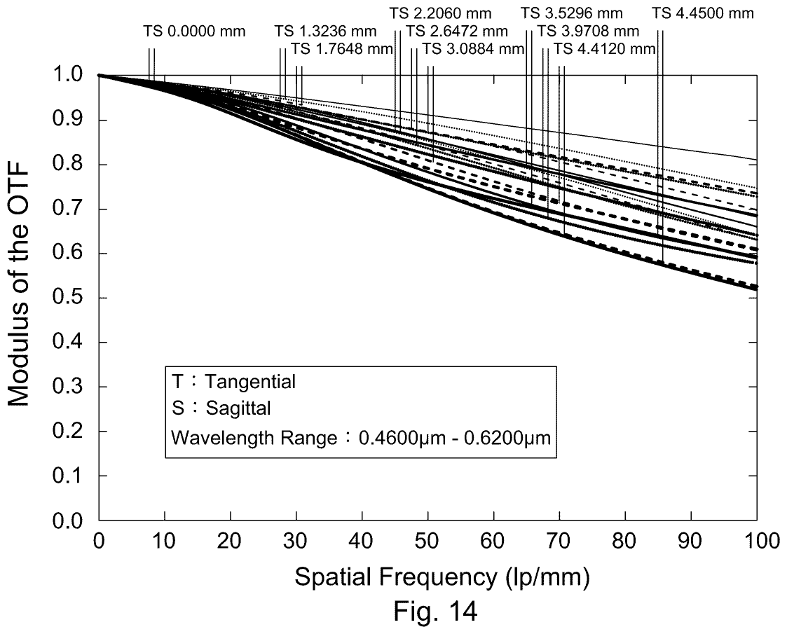

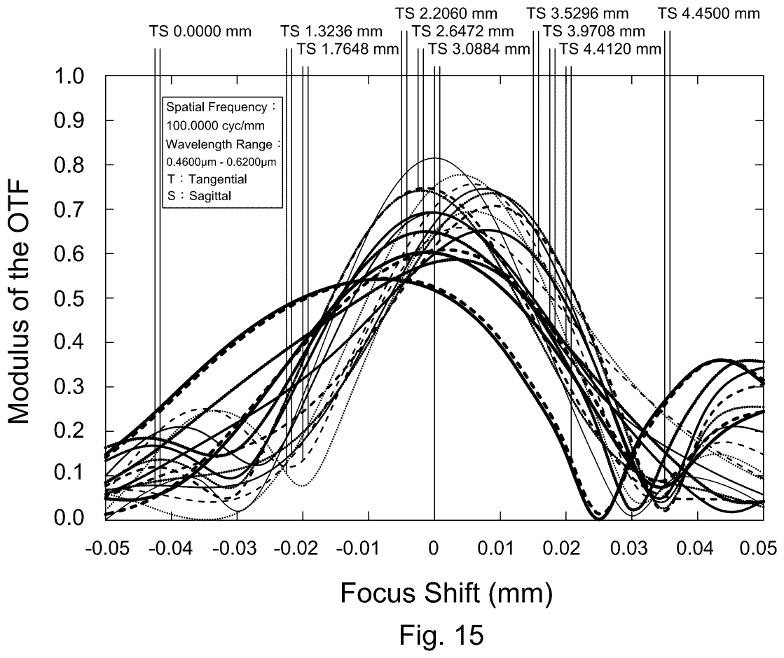

In addition, the lens assembly 5 of the fifth embodiment can meet the requirements of optical performance as seen in FIGS. 12-15. It can be seen from FIG. 12 that the field curvature of tangential direction and sagittal direction in the lens assembly 5 of the fifth embodiment ranges from −0.04 mm to 0.035 mm. It can be seen from FIG. 13 that the distortion in the lens assembly 5 of the fifth embodiment ranges from −1.2% to 0%. It can be seen from FIG. 14 that the modulation transfer function of tangential direction and sagittal direction in the lens assembly 5 of the fifth embodiment ranges from 0.52 to 1.0. It can be seen from FIG. 15 that the through focus modulation transfer function of tangential direction and sagittal direction in the lens assembly 5 of the fifth embodiment ranges from 0.0 to 0.81 as focus shift ranges from −0.05 mm to 0.05 mm. It is obvious that the field curvature and the distortion of the lens assembly 5 of the fifth embodiment can be corrected effectively, and the resolution and the depth of focus of the lens assembly 5 of the fifth embodiment can meet the requirement. Therefore, the lens assembly 5 of the fifth embodiment is capable of good optical performance.

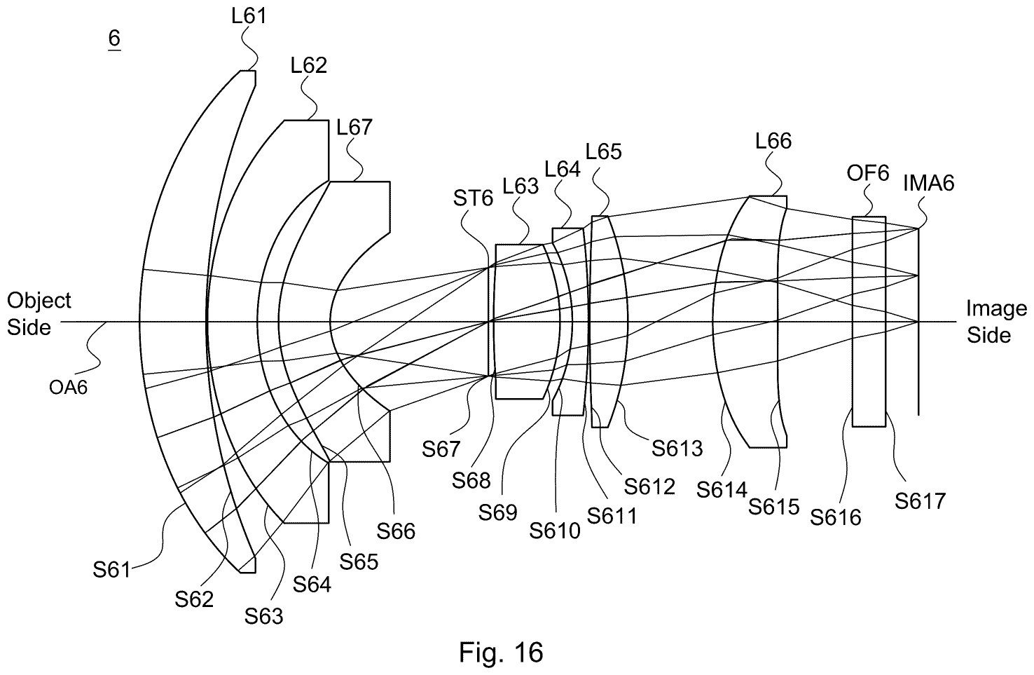

A detailed description of a lens assembly in accordance with a sixth embodiment of the invention is as follows. Referring to FIG. 16, the lens assembly 6 includes a first lens L61, a second lens L62, a seventh lens L67, a stop ST6, a third lens L63, a fourth lens L64, a fifth lens L65, a sixth lens L66, and an optical filter OF6, all of which are arranged in order from an object side to an image side along an optical axis OA6. In operation, the light from the object side is imaged on an image plane IMA6.

According to the foregoing, wherein: the object side surface S65 and the image side surface S66 of the seventh lens L67 are aspheric surfaces; the third lens L63 is a biconvex lens, wherein the object side surface S68 is a convex surface; the fourth lens L64 is with negative refractive power, wherein both of the object side surface S610 and image side surface S611 are spherical surfaces; both of the object side surface S616 and image side surface S617 of the optical filter OF6 are plane surfaces; and with the above design of the lenses, stop ST6, and at least one of the conditions (11), (15)-(16), and (22)-(30) satisfied, the lens assembly 6 can have an effective increased resolution, an effective decreased distortion, and an effective corrected aberration.

Table 16 shows the optical specification of the lens assembly 6 in FIG. 16.

TABLE 16
Effective Focal Length = 11.00 mm F-number = 2.15
Total Lens Length = 47.14 mm Field of View = 44.50 degrees

| | Radius of | | | | Effective | |
|---|---|---|---|---|---|---|
| Surface | Curvature | Thickness | | | Focal Length | |
| Number | (mm) | (mm) | Nd | Vd | (mm) | Remark |
| S61 | 14.78 | 4.02 | 1.82 | 46.55 | 41.85 | L61 |
| S62 | 22.72 | 0.08 | | | | |
| S63 | 12.22 | 3.01 | 1.60 | 65.46 | −40.58 | L62 |
| S64 | 7.40 | 1.29 | | | | |
| S65 | 5.85 | 3.13 | 1.54 | 56.12 | −14.92 | L67 |
| S66 | 2.75 | 9.57 | | | | |
| S67 | ∞ | 0.34 | | | | ST6 |
| S68 | 38.18 | 4.01 | 1.50 | 81.61 | 12.11 | L63 |
| S69 | −6.93 | 0.73 | | | | |
| S610 | −6.51 | 0.99 | 1.74 | 28.30 | −11.35 | L64 |
| S611 | −29.58 | 0.07 | | | | |
| S612 | 93.26 | 2.32 | 1.71 | 53.83 | 13.73 | L65 |
| S613 | −10.90 | 5.12 | | | | |
| S614 | 10.36 | 3.93 | 1.54 | 56.12 | 17.89 | L66 |
| S615 | −118.61 | 4.53 | | | | |
| S616 | ∞ | 2.00 | 1.52 | 54.52 | | OF6 |
| S617 | ∞ | 2.00 | | | | |

The definition of aspheric surface sag z of each aspheric lens in table 16 is the same as that of in Table 13, and is not described here again.

In the sixth embodiment, the conic constant k and the aspheric coefficients A, B, C, D, E, F of each aspheric lens are shown in Table 17.

TABLE 17

| Surface | | A | B | | |
|---|---|---|---|---|---|
| Number | k | E | F | C | D |
| S65 | −7.20E−01 | 0.00E+00 | −2.74E−04 | −6.69E−06 | −1.20E−07 |
| | | 5.06E−09 | −4.92E−11 | | |
| S66 | −1.01E+00 | 0.00E+00 | 1.34E−03 | −1.97E−05 | −1.56E−06 |
| | | 1.73E−07 | −4.16E−09 | | |
| S614 | 4.14E−01 | 0.00E+00 | 1.05E−04 | 1.88E−06 | 5.72E−09 |
| | | −1.06E−10 | −1.01E−12 | | |
| S615 | 0.00E+00 | 0.00E+00 | 6.88E−04 | −9.38E−07 | 3.05E−07 |
| | | −7.43E−09 | 5.73E−11 | | |

Table 18 shows the parameters and condition values for conditions (11), (15)-(16), and (22)-(30) in accordance with the sixth embodiment of the invention. It can be seen from Table 18 that the lens assembly 6 of the sixth embodiment satisfies the conditions (11), (15)-(16), and (22)-(30).

TABLE 18

| T1 | 4.02 mm | T6 | 2.32 | mm | BFL | 8.53 mm |
|---|---|---|---|---|---|---|
| CT1 | 7.12 mm | CT2 | 31.49 | mm | | |
| f7/f | 1.63 | \|f4/f5\| | 1.07 | | \|f6/f5\| | 1.21 |
| R12/T1 | 5.65 | R62/T6 | −4.70 | | \|R41/R42\| | 5.51 |
| (R12 − R11)/ | 1.66 | (R11 − R12)/ | −0.17 | | TTL/BFL | 5.53 |
| (R21 − R22) | | TTL | | | | |
| Vd4/Vd5 | 2.88 | fB + fC | −55.50 | mm | CT2/CT1 | 4.42 |

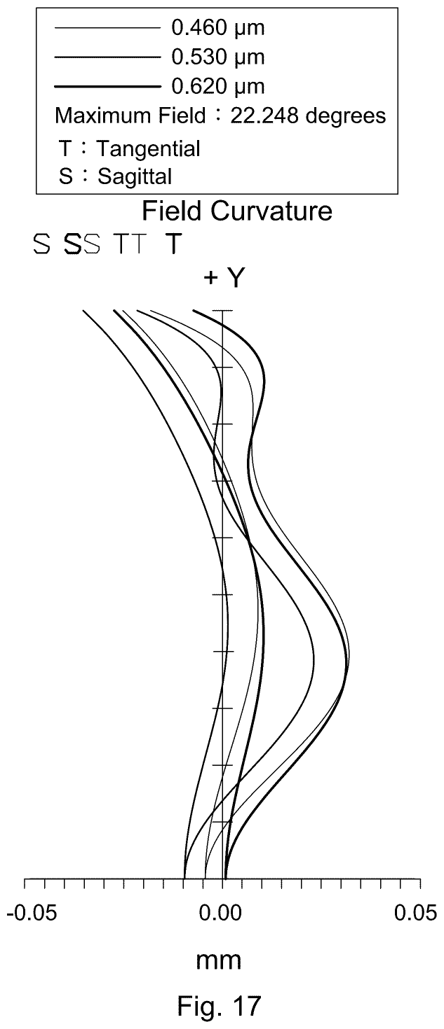

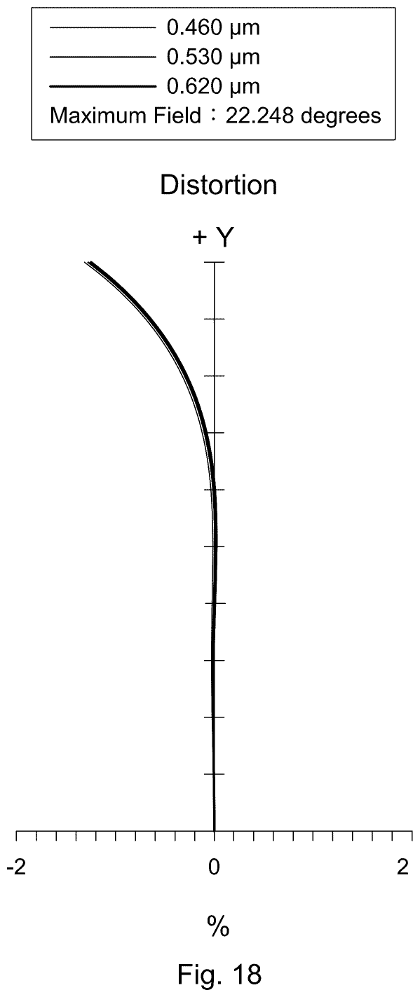

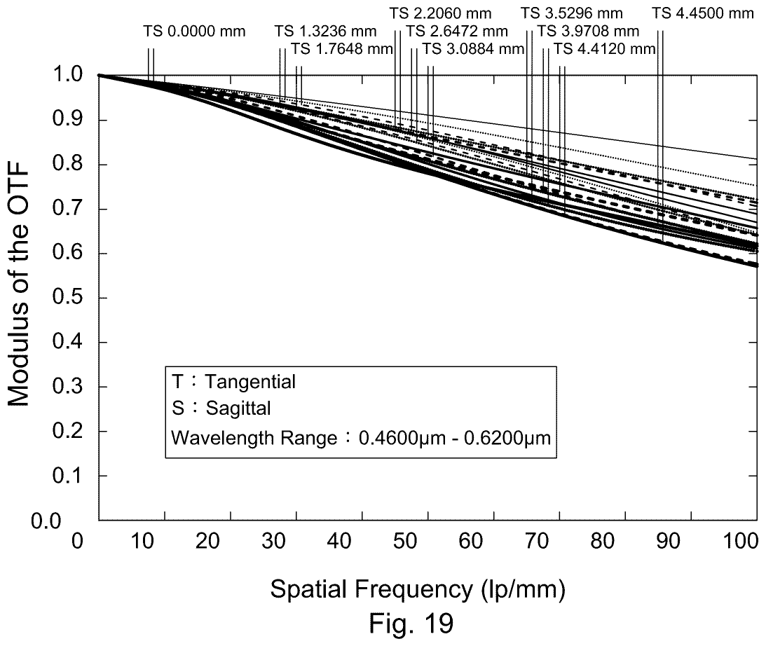

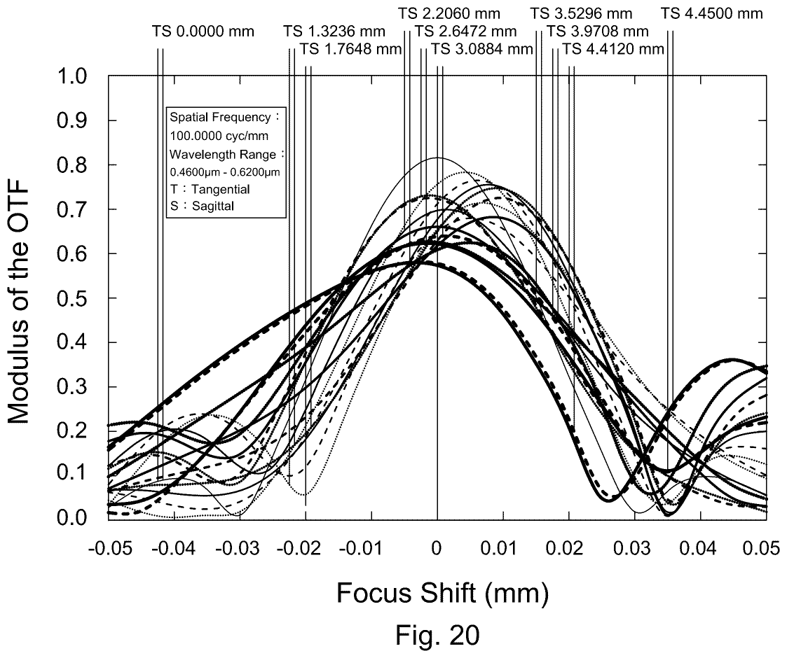

In addition, the lens assembly 6 of the sixth embodiment can meet the requirements of optical performance as seen in FIGS. 17-20. It can be seen from FIG. 17 that the field curvature of tangential direction and sagittal direction in the lens assembly 6 of the sixth embodiment ranges from −0.035 mm to 0.035 mm. It can be seen from FIG. 18 that the distortion in the lens assembly 6 of the sixth embodiment ranges from −1.4% to 0.2%. It can be seen from FIG. 19 that the modulation transfer function of tangential direction and sagittal direction in the lens assembly 6 of the sixth embodiment ranges from 0.58 to 1.0. It can be seen from FIG. 20 that the through focus modulation transfer function of tangential direction and sagittal direction in the lens assembly 6 of the sixth embodiment ranges from 0.0 to 0.82 as focus shift ranges from −0.05 mm to 0.05 mm. It is obvious that the field curvature and the distortion of the lens assembly 6 of the sixth embodiment can be corrected effectively, and the resolution and the depth of focus of the lens assembly 6 of the sixth embodiment can meet the requirement. Therefore, the lens assembly 6 of the sixth embodiment is capable of good optical performance.

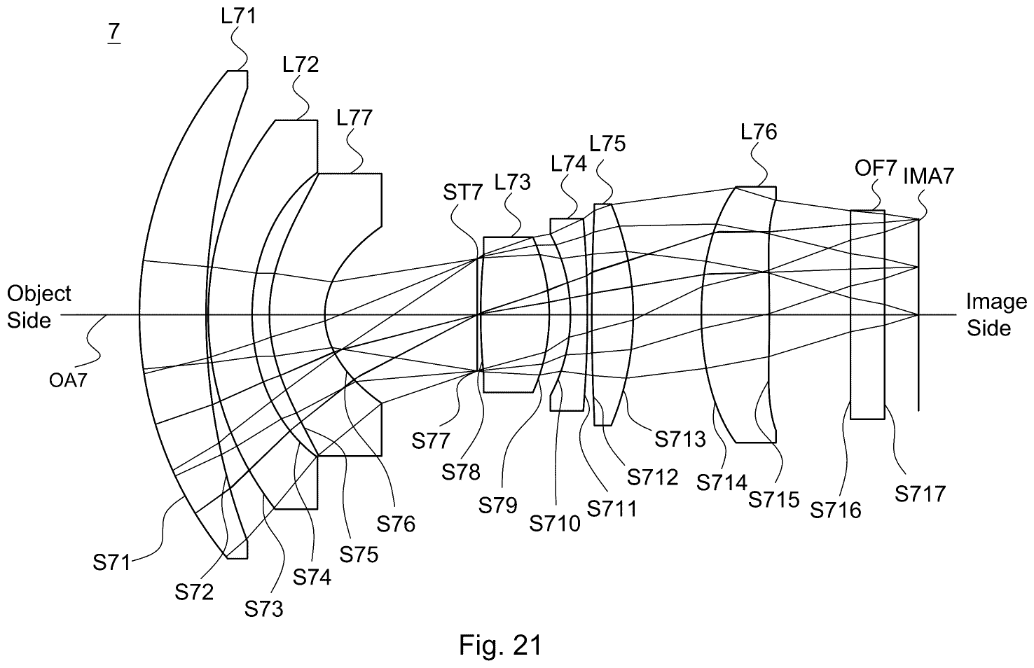

A detailed description of a lens assembly in accordance with a seventh embodiment of the invention is as follows. Referring to FIG. 21, the lens assembly 7 includes a first lens L71, a second lens L72, a seventh lens L77, a stop ST7, a third lens L73, a fourth lens L74, a fifth lens L75, a sixth lens L76, and an optical filter OF7, all of which are arranged in order from an object side to an image side along an optical axis OA7. In operation, the light from the object side is imaged on an image plane IMA7.

According to the foregoing, wherein: the object side surface S75 and the image side surface S76 of the seventh lens L77 are aspheric surfaces; the third lens L73 is a biconvex lens, wherein the object side surface S78 is a convex surface; the fourth lens L74 is with negative refractive power, wherein both of the object side surface S710 and image side surface S711 are spherical surfaces; both of the object side surface S716 and image side surface S717 of the optical filter OF7 are plane surfaces; and with the above design of the lenses, stop ST7, and at least one of the conditions (11), (15)-(16), and (22)-(30) satisfied, the lens assembly 7 can have an effective increased resolution, an effective decreased distortion, and an effective corrected aberration.

Table 19 shows the optical specification of the lens assembly 7 in FIG. 21.

TABLE 19
Effective Focal Length = 10.99 mm F-number = 2.14
Total Lens Length = 45.70 mm Field of View = 43.72 degrees

| | Radius of | | | | Effective | |
|---|---|---|---|---|---|---|
| Surface | Curvature | Thickness | | | Focal Length | |
| Number | (mm) | (mm) | Nd | Vd | (mm) | Remark |
| S71 | 14.85 | 3.92 | 1.82 | 46.55 | 39.77 | L71 |
| S72 | 23.96 | 0.09 | | | | |
| S73 | 12.19 | 2.58 | 1.60 | 65.46 | −41.39 | L72 |
| S74 | 7.55 | 1.02 | | | | |
| S75 | 5.96 | 3.24 | 1.54 | 56.12 | −14.21 | L77 |
| S76 | 2.71 | 8.95 | | | | |
| S77 | ∞ | 0.21 | | | | ST7 |
| S78 | 22.93 | 4.01 | 1.50 | 81.61 | 11.52 | L73 |
| S79 | −7.23 | 1.25 | | | | |
| S710 | −6.46 | 0.99 | 1.74 | 28.30 | −10.38 | L74 |
| S711 | −40.61 | 0.27 | | | | |
| S712 | 83.95 | 2.44 | 1.71 | 53.83 | 13.26 | L75 |
| S713 | −10.60 | 3.97 | | | | |
| S714 | 11.25 | 3.99 | 1.54 | 56.12 | 17.34 | L76 |
| S715 | −48.11 | 4.76 | | | | |
| S716 | ∞ | 2.00 | 1.52 | 54.52 | | OF7 |
| S717 | ∞ | 2.00 | | | | |

The definition of aspheric surface sag z of each aspheric lens in table 19 is the same as that of in Table 13, and is not described here again.

In the seventh embodiment, the conic constant k and the aspheric coefficients A, B, C, D, E, F of each aspheric lens are shown in Table 20.

TABLE 20

| Surface | | A | B | | |
|---|---|---|---|---|---|
| Number | k | E | F | C | D |
| S75 | −7.43E−01 | 0.00E+00 | −3.26E−04 | −6.29E−06 | −1.25E−07 |
| | | 6.07E−09 | −5.95E−11 | | |
| S76 | −1.02E+00 | 0.00E+00 | 1.26E−03 | −2.93E−05 | −6.54E−07 |
| | | 1.38E−07 | −1.78E−09 | | |
| S714 | 7.21E−01 | 0.00E+00 | 9.96E−05 | 2.43E−06 | 1.06E−08 |
| | | −2.65E−10 | 6.55E−12 | | |
| S715 | 0.00E+00 | 0.00E+00 | 6.79E−04 | 8.33E−07 | 3.33E−07 |
| | | −9.03E−09 | 1.28E−10 | | |

Table 21 shows the parameters and condition values for conditions (11), (15)-(16), and (22)-(30) in accordance with the seventh embodiment of the invention. It can be seen from Table 21 that the lens assembly 7 of the seventh embodiment satisfies the conditions (11), (15)-(16), and (22)-(30).

TABLE 18

| T1 | 3.92 mm | T6 | 2.44 | mm | BFL | 8.76 mm |
|---|---|---|---|---|---|---|
| CT1 | 6.6 mm | CT2 | 30.34 | mm | | |
| f7/f | 1.58 | \|f4/f5\| | 1.11 | | \|f6/f5\| | 1.28 |
| R12/T1 | 6.11 | R62/T6 | −4.35 | | \|R41/R42\| | 3.17 |
| (R12 − R11)/ | 1.96 | (R11 − R12)/ | −0.20 | | TTL/BFL | 5.22 |
| (R21 − R22) | | TTL | | | | |
| Vd4/Vd5 | 2.88 | fB + fC | −55.60 | mm | CT2/CT1 | 4.60 |

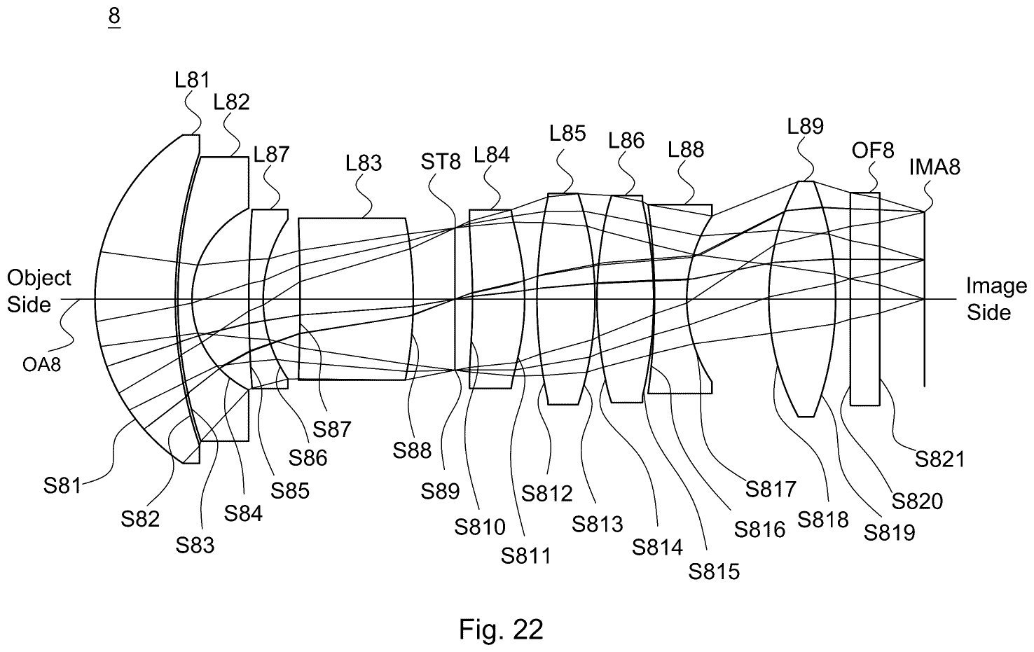

A detailed description of a lens assembly in accordance with an eighth embodiment of the invention is as follows. Referring to FIG. 22, the lens assembly 8 includes a first lens L81, a second lens L82, a seventh lens L87, a third lens L83, a stop ST8, a fourth lens L84, a fifth lens L85, a sixth lens L86, an eighth lens L88, a ninth lens L89, and an optical filter OF8, all of which are arranged in order from an object side to an image side along an optical axis OA8. In operation, the light from the object side is imaged on an image plane IMA8.

According to the foregoing, wherein: the object side surface S85 and the image side surface S86 of the seventh lens L87 are spherical surfaces; the third lens L83 is a meniscus lens, wherein the object side surface S87 is a concave surface; the fourth lens L84 is with positive refractive power, wherein both of the object side surface S810 and image side surface S811 are aspheric surfaces; the eighth lens L88 is a biconcave lens with negative refractive power, wherein the object side surface S816 is a concave surface, the image side surface S817 is a concave surface, and both of the object side surface S816 and image side surface S817 are spherical surfaces; the ninth lens L89 is a biconvex lens with positive refractive power, wherein the object side surface S818 is a convex surface, the image side surface S819 is a convex surface, and both of the object side surface S818 and image side surface S819 are aspheric surfaces; both of the object side surface S820 and image side surface S821 of the optical filter OF8 are plane surfaces; and with the above design of the lenses, stop ST8, and at least one of the conditions (11), (15)-(16), and (22)-(30) satisfied, the lens assembly 8 can have an effective increased resolution, an effective decreased distortion, and an effective corrected aberration.

Table 22 shows the optical specification of the lens assembly 8 in FIG. 22.

TABLE 22
Effective Focal Length = 11.00 mm F-number = 1.80
Total Lens Length = 57.00 mm Field of View = 54.49 degrees

| | Radius of | | | | Effective | |
|---|---|---|---|---|---|---|
| Surface | Curvature | Thickness | | | Focal Length | |
| Number | (mm) | (mm) | Nd | Vd | (mm) | Remark |
| S81 | 12.07 | 5.53 | 2.00 | 25.43 | 18.09 | L81 |
| S82 | 27.16 | 0.16 | | | | |
| S83 | 26.77 | 1.00 | 1.95 | 17.94 | −8.68 | L82 |
| S84 | 6.26 | 3.88 | | | | |
| S85 | 72.02 | 1.00 | 1.50 | 81.61 | −19.40 | L87 |
| S86 | 8.50 | 2.54 | | | | |
| S87 | −108.72 | 7.75 | 1.96 | 17.47 | 32.30 | L83 |
| S88 | −25.34 | 2.88 | | | | |
| S89 | ∞ | 1.21 | | | | ST8 |
| S810 | −41.40 | 3.58 | 1.62 | 62.91 | 35.49 | L84 |
| S811 | −14.84 | 0.84 | | | | |
| S812 | 28.27 | 4.03 | 1.59 | 67.29 | 19.93 | L85 |
| S813 | −19.43 | 0.10 | | | | |
| S814 | 19.12 | 3.87 | 1.62 | 62.91 | 21.15 | L86 |
| S815 | −38.49 | 0.09 | | | | |
| S816 | −40.37 | 2.19 | 1.85 | 23.78 | −8.30 | L88 |
| S817 | 8.87 | 5.68 | | | | |
| S818 | 14.32 | 4.57 | 1.62 | 62.91 | 13.02 | L89 |
| S819 | −16.22 | 1.00 | | | | |
| S820 | ∞ | 2.00 | 1.52 | 54.52 | | OF8 |
| S821 | ∞ | 3.10 | | | | |

The definition of aspheric surface sag z of each aspheric lens in table 22 is the same as that of in Table 13, and is not described here again.

In the eighth embodiment, the conic constant k and the aspheric coefficients A, B, C, D, E, F of each aspheric lens are shown in Table 23.

TABLE 23

| Surface | | A | B | | |
|---|---|---|---|---|---|
| Number | k | E | F | C | D |
| S810 | 4.82E+01 | 0.00E+00 | 4.43E−05 | 5.67E−06 | 1.65E−07 |
| | | 0.00E+00 | 0.00E+00 | | |
| S811 | 8.19E−01 | 0.00E+00 | −3.09E−05 | 5.25E−06 | 9.36E−08 |
| | | 0.00E+00 | 0.00E+00 | | |
| S814 | −8.73E+00 | 0.00E+00 | −1.24E−04 | 2.29E−06 | 2.74E−08 |
| | | 0.00E+00 | 0.00E+00 | | |
| S815 | 2.25E+01 | 0.00E+00 | −3.34E−04 | 6.19E−06 | 5.16E−09 |
| | | 0.00E+00 | 0.00E+00 | | |
| S818 | 9.64E−02 | 0.00E+00 | −6.51E−05 | 4.10E−07 | −1.49E−09 |
| | | 0.00E+00 | 0.00E+00 | | |
| S819 | −7.36E+00 | 0.00E+00 | −5.99E−05 | 8.23E−08 | 2.44E−09 |
| | | 0.00E+00 | 0.00E+00 | | |

Table 24 shows the parameters and condition values for conditions (11), (15)-(16), and (22)-(30) in accordance with the eighth embodiment of the invention. It can be seen from Table 24 that the lens assembly 8 of the eighth embodiment satisfies the conditions (11), (15)-(16), and (22)-(30).

TABLE 24

| T1 | 5.53 mm | T6 | 4.03 | mm | BFL | 6.10 mm |
|---|---|---|---|---|---|---|
| CT1 | 6.69 mm | CT2 | 31.67 | mm | | |
| f7/f | 1.92 | \|f4/f5\| | 0.91 | | \|f6/f5\| | 0.56 |
| R12/T1 | 4.91 | R62/T6 | −4.83 | | \|R41/R42\| | 4.29 |
| (R12 − R11)/ | 0.74 | (R11 − R12)/ | −0.26 | | TTL/BFL | 9.35 |
| (R21 − R22) | | TTL | | | | |
| Vd4/Vd5 | 0.28 | fB + fC | −28.08 | mm | CT2/CT1 | 4.73 |

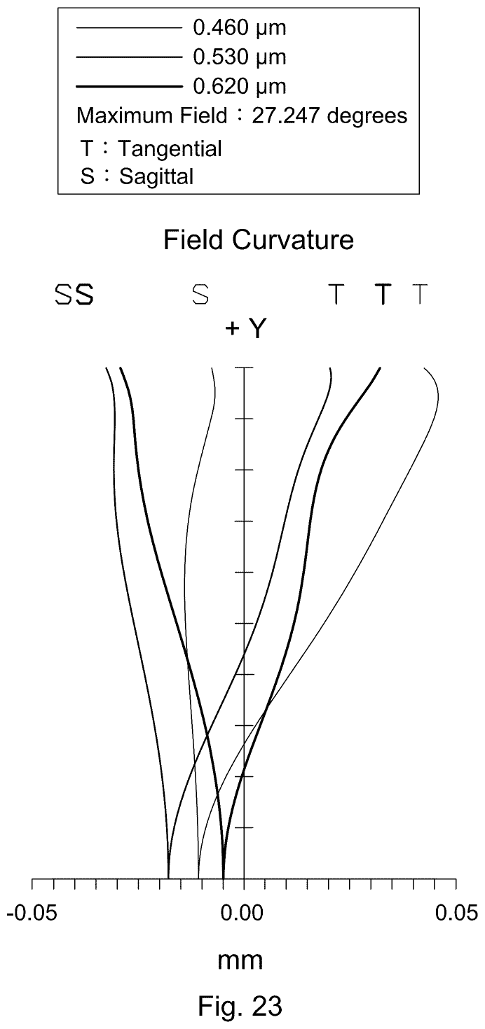

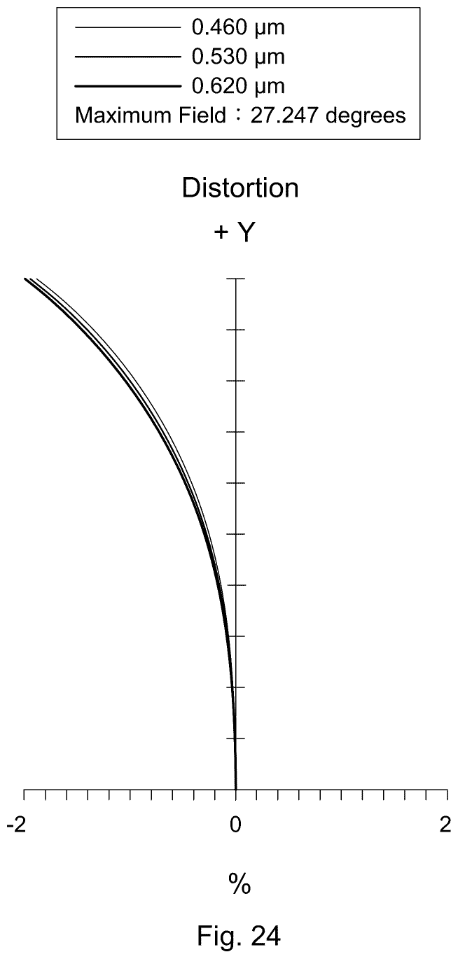

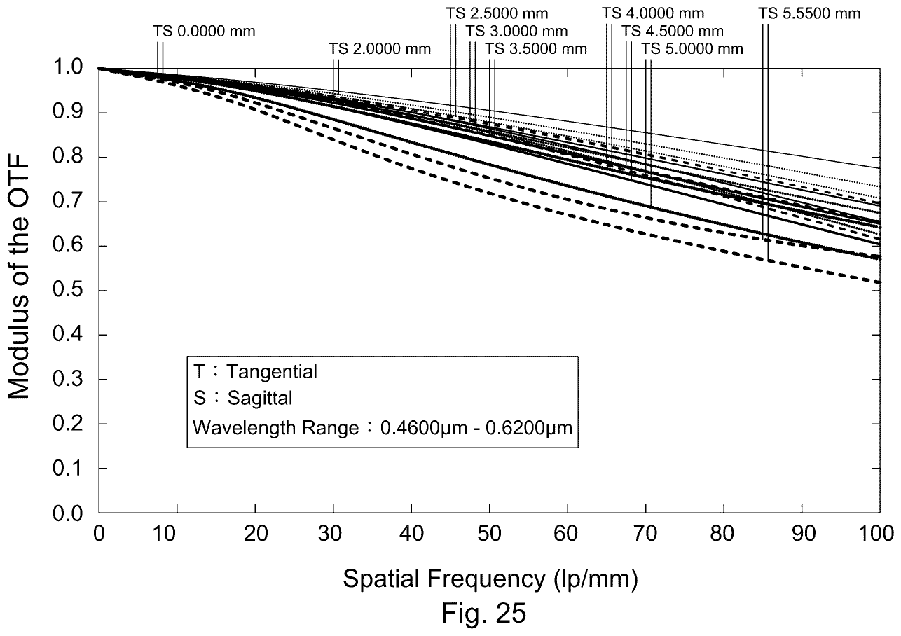

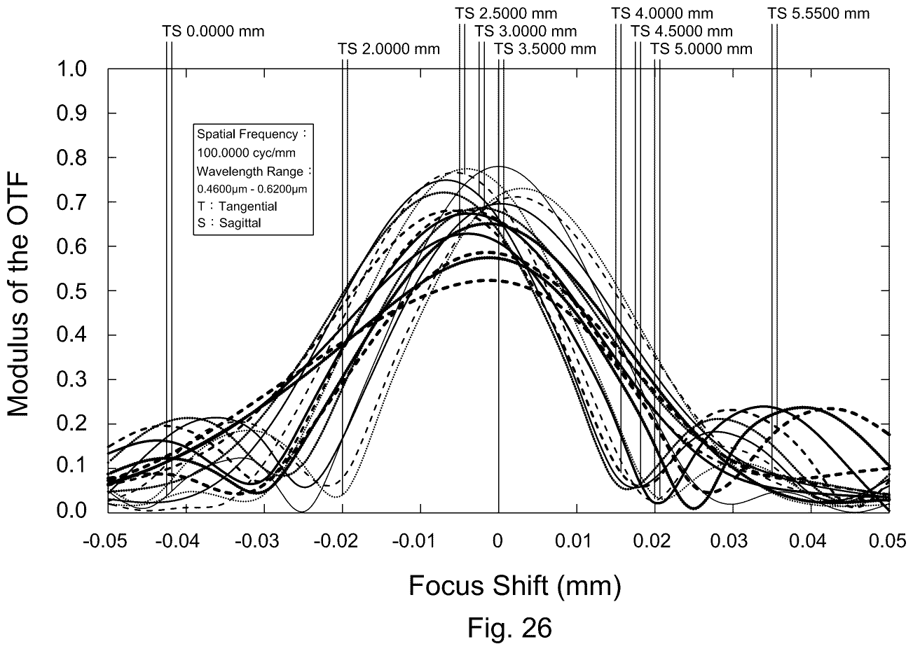

In addition, the lens assembly 8 of the eighth embodiment can meet the requirements of optical performance as seen in FIGS. 23-26. It can be seen from FIG. 23 that the field curvature of tangential direction and sagittal direction in the lens assembly 8 of the eighth embodiment ranges from −0.035 mm to 0.045 mm. It can be seen from FIG. 24 that the distortion in the lens assembly 8 of the eighth embodiment ranges from −2% to 0%. It can be seen from FIG. 25 that the modulation transfer function of tangential direction and sagittal direction in the lens assembly 8 of the eighth embodiment ranges from 0.52 to 1.0. It can be seen from FIG. 26 that the through focus modulation transfer function of tangential direction and sagittal direction in the lens assembly 8 of the eighth embodiment ranges from 0.0 to 0.78 as focus shift ranges from −0.05 mm to 0.05 mm. It is obvious that the field curvature and the distortion of the lens assembly 8 of the eighth embodiment can be corrected effectively, and the resolution and the depth of focus of the lens assembly 8 of the eighth embodiment can meet the requirement. Therefore, the lens assembly 8 of the eighth embodiment is capable of good optical performance.

In the above embodiments, the first, second, and third embodiments further satisfy condition (24): 0.4≤|fF/fE|≤1.3; the first embodiment further satisfies condition (27): 3≤|R41/R42|≤5.7; the first and fourth embodiments further satisfy condition (28): 0.6≤(R12-R11)/(R21-R22)≤2.2; the first, second, and third embodiments further satisfy condition (30): 5≤TTL/BFL≤10; the fifth, sixth, and seventh embodiments further satisfy condition (14): −3≤fE+fF≤9; the fifth, sixth, and seventh embodiments further satisfy condition (2): 6.1≤TTL/CT1≤7.4; and the corresponding condition values are shown in Table 25.

TABLE 25

| | Embodiment 1 | Embodiment 2 | Embodiment 3 | Embodiment 4 |
|---|---|---|---|---|
| \|fF/fE\| | 0.97 | 0.63 | 0.5 | — |
| \|R41/R42\| | 4.48 | — | — | — |
| (R12 − R11)/ | 1.21 | — | — | 1.23 |
| (R21 − R22) | | | | |
| TTL/BFL | 9.24 | 7.60 | 9.48 | — |
| | Embodiment 5 | Embodiment 6 | Embodiment 7 | — |
| fE + fF | 2.23 mm | 2.38 mm | 2.88 mm | — |
| TTL/CT1 | 6.64 | 6.62 | 6.92 | — |

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A lens assembly comprising:
a first lens which is a meniscus lens with positive refractive power and comprises a convex surface facing an object side and a concave surface facing an image side;
a second lens which is a meniscus lens with negative refractive power and comprises a convex surface facing the object side and a concave surface facing the image side;
a third lens which is with refractive power;
a fourth lens which is with refractive power and comprises a convex surface facing the image side;
a fifth lens which is a biconvex lens with positive refractive power and comprises a convex surface facing the object side and another convex surface facing the image side; and
a sixth lens which is with refractive power;
wherein the first lens, the second lens, the third lens, the fourth lens, the fifth lens, and the sixth lens are arranged in order from the object side to the image side along an optical axis;
wherein the lens assembly satisfies at least one of following conditions:
$$- 1 \; 00 mm \leq fB + f C \leq 50 mm ;$$
$$1 \leq CT 2 / CT 1 \leq 7 ;$$
$$2 \leq Vd 4 / Vd 5 \leq 3.1 ;$$
$$6.1 < TTL / CT 1 < 7.4 ;$$
$$- 3 mm \leq fE + f F \leq 9 mm ;$$
$$4 \leq \vert fF / fE \vert \leq 1.3 ;$$
$$0.6 \leq ( R 12 - R 11 ) / ( R 21 - R 22 ) \leq 2.2 ;$$
$$5 \leq TTL / BFL \leq 10 ;$$
wherein fB is an effective focal length of the lens second closest to the object side, fC is an effective focal length of the lens third closest to the object side, CT1 is an interval from an object side surface of the first lens to an image side surface of the second lens along the optical axis, CT2 is an interval from the image side surface of the second lens to an image side surface of the sixth lens along the optical axis, Vd4 is an Abbe number of the lens fourth closest to the object side, Vd5 is an Abbe number of the lens fifth closest to the object side, TTL is an interval from the object side surface of the first lens to an image plane along the optical axis, R11 is a radius of curvature of the object side surface of the first lens, R12 is a radius of curvature of an image side surface of the first lens, R21 is a radius of curvature of an object side surface of the second lens, R22 is a radius of curvature of the image side surface of the second lens, fE is an effective focal length of the lens fifth closest to the object side, fF is an effective focal length of the lens sixth closest to the object side, and BFL is an interval from an image side surface of the lens closest to the image side to the image plane along the optical axis.

2. The lens assembly as claimed in claim 1, wherein:
the third lens is a meniscus lens; and
the sixth lens is with negative refractive power.

3. The lens assembly as claimed in claim 2, wherein the sixth lens is a biconcave lens and further comprises another concave surface facing the object side.

4. The lens assembly as claimed in claim 3, wherein the third lens is with positive refractive power and comprises a concave surface facing the object side and a convex surface facing the image side.

5. The lens assembly as claimed in claim 4, wherein the fourth lens is a meniscus lens with negative refractive power and further comprises a concave surface facing the object side.

6. The lens assembly as claimed in claim 4, further comprising a seventh lens disposed between the second lens and the third lens, wherein the seventh lens is a biconcave lens with negative refractive power and comprises a concave surface facing the object side and another concave surface facing the image side.

7. The lens assembly as claimed in claim 2, wherein the third lens is with negative refractive power and comprises a convex surface facing the object side and a concave surface facing the image side.

8. The lens assembly as claimed in claim 7, wherein the fourth lens is a biconvex lens with positive refractive power and further comprises another convex surface facing the object side.

9. The lens assembly as claimed in claim 1, further comprising a stop disposed between the object side and the first lens, wherein the first lens and the second lens are cemented.

10. The lens assembly as claimed in claim 1, wherein the lens assembly satisfies at least one of following conditions:
$$11.9 < ( f + T TL ) / CT 1 < 13.3 ;$$
$$6 < ( f + B FL ) / CT 1 < 7 ;$$
$$27 {mm}^{2} < fA \times D 1 obj < 51 {mm}^{2} ;$$
$$2. < TTL + B FL ) / D 1 obj < 3.3 ;$$
$$7 mm < D 1 obj + R 11 < 11 mm ;$$
$$15 mm < f + C T 2 < 18 mm ;$$
$$3.5 < TTL / BFL ) - ( D 1 obj / BFL ) < 6.1 ;$$
$$9.3 {mm}^{2} < f \times T 1 < 12.5 {mm}^{2} ;$$
$$TC 12 = 0 mm ;$$
$$- 60 mm \leq fA + f D \leq 50 mm ;$$
$$- 3 \leq f / ( fA + f B ) \leq - 0.1 ;$$
wherein f is an effective focal length of the lens assembly, fA is an effective focal length of the lens closest to the object side, TTL is the interval from the object side surface of the first lens to the image plane along the optical axis, BFL is the interval from the image side surface of the lens closest to the image side to the image plane along the optical axis, T1 is an interval from the object side surface of the first lens to the image side surface of the first lens along the optical axis, CT1 is the interval from the object side surface of the first lens to the image side surface of the second lens along the optical axis, CT2 is the interval from the image side surface of the second lens to the image side surface of the sixth lens along the optical axis, D1obj is an effective optical diameter of the object side surface of the first lens, R11 is the radius of curvature of the object side surface of the first lens, TC12 is an interval from the image side surface of the first lens to the object side surface of the second lens along the optical axis, fD is an effective focal length of the lens fourth closest to the object side, and fB is the effective focal length of the lens second closest to the object side.

11. The lens assembly as claimed in claim 1, further comprising a seventh lens disposed between the second lens and the third lens, wherein the seventh lens comprises a concave surface facing the image side.

12. The lens assembly as claimed in claim 11, wherein:
the third lens is with positive refractive power;
the sixth lens is with positive refractive power; and
the seventh lens is with negative refractive power.

13. The lens assembly as claimed in claim 12, wherein:
the fourth lens is a meniscus lens and further comprises a concave surface facing the object side;
the sixth lens is a biconvex lens and comprises a convex surface facing the object side and another convex surface facing the image side; and
the seventh lens is a meniscus lens and further comprises a convex surface facing the object side.

14. The lens assembly as claimed in claim 13, wherein:
the third lens is a biconvex lens and comprises a convex surface facing the object side and another convex surface facing the image side; and
the fourth lens is with negative refractive power.

15. The lens assembly as claimed in claim 13, further comprising an eighth lens disposed between the sixth lens and the image side and a ninth lens disposed between the eighth lens and the image side, wherein:
the eighth lens is with negative refractive power; and
the ninth lens is with positive refractive power.

16. The lens assembly as claimed in claim 15, wherein the eighth lens is a biconcave lens and comprises a concave surface facing the object side and another concave surface facing the image side.

17. The lens assembly as claimed in claim 16, wherein the ninth lens is a biconvex lens and comprises a convex surface facing the object side and another convex surface facing the image side.

18. The lens assembly as claimed in claim 15, wherein:
the third lens is a meniscus lens and comprises a concave surface facing the object side and a convex surface facing the image side; and
the fourth lens is with positive refractive power.

19. The lens assembly as claimed in claim 1, wherein the lens assembly satisfies at least one of following conditions:
$$1.56 \leq fG / f \leq 1.94 ;$$
$$0.8 \leq \vert fD / fE \vert \leq 1.2 ;$$
$$4.8 \leq R 12 / T 1 \leq 6.2 ;$$
$$- 4.9 \leq R 62 / T 6 \leq - 4.3 ;$$
$$3 \leq \vert R 41 / R 42 \vert \leq 5.7 ;$$
$$- 0.27 \leq ( R 11 - R 12 ) / TTL \leq - 0 \text{.16} ;$$
wherein f is an effective focal length of the lens assembly, fD is an effective focal length of the lens fourth closest to the object side, fE is the effective focal length of the lens fifth closest to the object side, fG is an effective focal length of the lens seventh closest to the object side, R11 is the radius of curvature of the object side surface of the first lens, R12 is the radius of curvature of the image side surface of the first lens, R41 is a radius of curvature of an object side surface of the lens fourth closest to the object side, R42 is a radius of curvature of an image side surface of the lens fourth closest to the object side, R62 is a radius of curvature of an image side surface of the lens sixth closest to the object side, T1 is an interval from the object side surface of the first lens to the image side surface of the first lens along the optical axis, T6 is an interval from an object side surface of the lens sixth closest to the object side to an image side surface of the lens sixth closest to the object side along the optical axis, and TTL is the interval from the object side surface of the first lens to the image plane along the optical axis.

20. The lens assembly as claimed in claim 11, further comprising a stop disposed between the seventh lens and the third lens or disposed between the third lens and the fourth lens.
